(19) United States
(12) Patent Application Publication
(10) Pub. No.: US 2025/0051930 A1
(43) Pub. Date: Feb. 13, 2025

(54) METHOD FOR RECYCLING OF PCB COPPER CHLORIDE ETCHING WASTE SOLUTION THROUGH PRECIPITATION TREATMENT, AND APPARATUS APPLICABLE THERETO

(71) Applicants: Tao Ye, Guangzhou (CN); Yiting Ye, Guangzhou (CN)

(72) Inventors: Tao Ye, Guangzhou (CN); Yiting Ye, Guangzhou (CN)

(21) Appl. No.: 18/928,307

(22) Filed: Oct. 28, 2024

Related U.S. Application Data
(63) Continuation of application No. PCT/CN2023/090931, filed on Apr. 26, 2023.

(30) Foreign Application Priority Data
Apr. 26, 2022 (CN) 202210443317.7
Jul. 29, 2022 (CN) 202210902464.6
Oct. 25, 2022 (CN) 202211315698.7
Dec. 23, 2022 (CN) 202211661840.3

(51) Int. Cl. C23F 1/46

(52) U.S. Cl. CPC C23F 1/46

(57) ABSTRACT

The present disclosure discloses a method for recycling of PCB copper chloride etching waste solution through precipitation treatment and an apparatus applicable thereto, including mixing a PCB copper chloride etching waste solution with a pH value adjusting agent for reaction, so that copper salt precipitates in the solution, and at least one of the PCB copper chloride etching waste solution and the pH value adjusting agent contains a PCB copper chloride etching waste solution containing ammonium and/or ammonia; and, subjecting a solid-liquid mixture obtained in step (1) to SLS to obtain filtrate A and filter residue C; and carrying out ammonia nitrogen removal treatment on the filter residue C to generate recovered copper products; and finally, reusing all or part of the filtrate A directly or after composition adjustment to the PCB copper chloride etching system as a regenerated etching replenishment solution and/or an etching oxidant solution.

### CROSS-REFERENCE TO RELATED APPLICATIONS

The present application is a continuation application of PCT application No. PCT/CN2023/090931 filed on Apr. 26, 2023, which claims the benefit of Chinese Patent Application No. 202210443317.7 filed on Apr. 26, 2022, Chinese Patent Application No. 202210902464.6 filed on Jul. 29, 2022, Chinese Patent Application No. 202211315698.7 filed on Oct. 25, 2022 and Chinese Patent Application No. 202211661840.3 filed on Dec. 23, 2022. The contents of all of the aforementioned applications are incorporated by reference herein in their entirety.

### TECHNICAL FIELD

The present disclosure belongs to the technical field of recovery treatment and recycling of PCB etching waste solution, and specifically relates to a method for recycling of PCB copper chloride etching waste solution through precipitation treatment, and an apparatus applicable thereto.

### BACKGROUND

Etching is an important step in the existing printed circuit board (PCB) fabrication process. At present, the commonly used etching solutions for PCB production include acid copper chloride etching solutions and alkaline copper chloride ammonia etching solutions. In the industry, it is collectively referred to as copper chloride etching process for PCBs, which makes it different from other PCB etching processes such as sulfuric acid/hydrogen peroxide type, organic acid type, persulfate type, chromic acid/sulfuric acid type etching processes.

The main components of the working acid copper chloride etching solution are hydrochloric acid and copper chloride, and some formulas also contain ammonium chloride and/or sodium chloride and/or ferric chloride.

The main components of the alkaline cupric chloride ammonium etching solution are copper salts of cupric chloride ammonium complexes, ammonium chloride, and ammonia solution, among which ammonium bicarbonate and/or ammonium carbonate and/or organic acid amines can be used as additives.

In actual etching production, as copper metal reacts with the working etching solution in the etching tank, the proportion of various components in the solution will constantly change. In order to ensure stable etching performance, it is necessary to add new etching solution to the working etching solution in the etching production line. The added new etching solution is called etching replenishment solution in the industry, and the solution overflowed from the etching production line is called etching waste solution.

At present, there are acidification method, extraction method and electrolysis method in the industry for recycling of alkaline cupric chloride ammonia etching waste solution.

(1) The acidification method is to directly add sulfuric acid to the alkaline cupric chloride ammonia etching waste solution, and then use electrolysis to recover metal copper through electrochemical reduction after the copper sulfate is obtained, but the remaining salt solution cannot be recycled to the etching process because it contains a large amount of ammonium sulfate that does not exist in the alkaline cupric chloride ammonia etching process.

(2) The extraction method is to use a strong organic chelating agent to extract the copper ions in the etching waste solution, and the remaining liquid is used to prepare the regenerated etching replenishment solution, and then use sulfuric acid to back-extract the organic extractant containing chelated copper ions to obtain copper sulfate, followed by recovering copper metal by electrolysis. Although the extraction method has a high recycling rate of production raw materials, a large amount of free ammonia is produced due to the destruction of the copper-ammonia complex during the recovery process. The vigorous stirring required in the extraction process causes the ammonia gas to easily escape. In addition, there is a chelating agent in the residual etching waste solution after extraction, which will lead to the regenerated etching replenishment solution containing organic chelating agent impurities, which will affect the efficiency and quality of etching production.

(3) The electrolysis method is to directly use the alkaline cupric chloride ammonia etching waste solution as the electrolyte for electrolysis to obtain copper. During the electrolysis process, the copper-ammonia complex is destroyed to release free ammonia, which resulting in a large amount of ammonia volatilization as the heat generated during the electrolysis process greatly reduces the solubility of ammonia. In addition, since the electrolyte contains a large amount of ammonium ions and chloride ions at the same time, there is a possibility of producing nitrogen trichloride, an explosive and dangerous product during the electrolysis process. And chlorine gas is produced during the electrolysis process, which reacts with the ammonia in the electrolyte solution and converts it into nitrogen, resulting in waste of ammonia, resulting in poor economic benefits for this copper recovery method.

There are alkalization method and electrolysis method for the recycling of acid copper chloride etching waste solution.

(1) The alkalization method is to use one or a combination of two or more selected from the group consisting of sodium hydroxide, potassium hydroxide, ammonium hydroxide, sodium carbonate, and sodium bicarbonate for neutralization reaction to form copper hydroxide and/or copper carbonate precipitation, and perform solid-liquid separation (SLS) to collect copper element. However, for those acidic etching solution containing ammonium chloride, or when ammonium hydroxide is used in the alkalization method for the recycling of the acid copper chloride etching waste solution, the resulting copper-containing precipitate contains ammonium salt impurities, which is difficult to remove through the existing environmental protection treatment technology, and affects the recycling of copper compound products in the next step.

(2) When using the electrolysis method, each etching production line needs to be equipped with several large-scale electrolysis equipment which is worth millions of yuan. Electrolysis equipment is expensive due to the installation of multiple metal electrodes and diaphragms, and a large amount of electric energy is consumed during use to realize the conversion from copper ions to metal copper, resulting in large investment, high energy consumption and heavy maintenance costs for electrolysis equipment.

Therefore, there are a variety of imperfect process problems in the existing PCB acid and alkaline copper chloride etching waste recovery process, so the industry is looking forward to the introduction of a new process that can be safer and simpler, with less equipment investment, a higher recycling rate, and even 100% recycling.

### SUMMARY

A first objective of the present disclosure is to provide a method for recycling of PCB copper chloride etching waste solution containing ammonium and/or ammonia through precipitation treatment. The equipment investment cost is low, the maintenance cost is low, the environmental pollution in the treatment process is small, and the remaining liquid after removing copper can be recycled to improve production income.

A second objective of the present disclosure is to provide an apparatus for recycling of PCB copper chloride etching waste solution through precipitation treatment, which is suitable for the method mentioned above.

The first objective of the present disclosure is implemented by the following technical solutions:

A method for recycling of PCB copper chloride etching waste solution containing ammonium and/or ammonia through precipitation treatment, including the following steps:
(1) mixing a PCB copper chloride etching waste solution with a pH value adjusting agent for reaction, so that copper salt precipitates in the solution and a solid-liquid mixture is obtained, and at least one of the PCB copper chloride etching waste solution and the pH value adjusting agent contains a PCB copper chloride etching waste solution containing ammonium and/or ammonia; and
(2) subjecting a solid-liquid mixture obtained in step (1) to SLS to obtain filtrate A and filter residue C; and
(3) carrying out ammonia nitrogen removal treatment on the filter residue C to generate recovered copper products; and
(4) reusing all or part of the filtrate A directly or after composition adjustment to the PCB copper chloride etching system as a regenerated etching replenishment solution and/or an etching oxidant solution.

The working principle of the present disclosure is that after neutralizing the etching waste solution containing ammonium and/or ammonia, a copper compound precipitation or its mixture with an iron compound—a so-called filter residue (see below for specific reaction formula) is obtained, and then the filter residue is treated by ammonia nitrogen removal process to recover copper products and the filtrate is reused directly or after composition adjustment as an etching replenishment solution and/or etching oxidant solution.

Wherein, at least one selected from the group consisting of the PCB copper chloride etching waste solution and the pH value adjusting agent mentioned in step (1) contains ammonium and/or ammonia. The PCB copper chloride etching waste solution is at least one selected from the group consisting of PCB acid copper chloride etching waste solution and/or PCB alkaline copper chloride ammonium etching waste solution, which can be a PCB copper chloride etching waste solution, or a mixure of more than one PCB copper chloride etching waste solutions.

The filtrate A mentioned in the step (3) of the present disclosure can be used directly or in part as an acidic regenerated etching replenishment solution and/or an acidic etching oxidant solution in the PCB acid copper chloride etching system directly or after composition adjustment; it can also be used directly or in part as a regenerated alkaline etching replenishment solution in the PCB alkaline copper chloride ammonia etching system.

The main component of the recovered copper product mentioned in step (3) of the present disclosure is at least one selected from the group consisting of copper hydroxide, copper carbonate, basic copper carbonate, copper oxide and percuprate salt.

The pH value adjusting agent in step (1) of the present disclosure includes acidic pH value adjusting agent and alkaline pH value adjusting agent. The acidic pH value adjusting agent is at least one selected from the group consisting of PCB acid copper chloride etching waste solution, hydrochloric acid, organic acid, and carbon dioxide. The alkaline pH value adjusting agent is at least one selected from the group consisting of PCB alkaline cupric chloride ammonia etching waste solution, sodium hydroxide, potassium hydroxide, ammonia and/or ammonium hydroxide, sodium carbonate, sodium bicarbonate, potassium bicarbonate, ammonium carbonate, and ammonium bicarbonate.

Preferably, the organic acid in the acidic pH value adjusting agent is formic acid. When formic acid is included in the acidic pH value adjusting agent, the obtained filtrate A also contains formate ions. The acidic regenerated etching replenishment solution prepared from filtrate A contains formic acid, and when it is reused in the acid etching production, the oxidizing agent added to the acidic etching process can oxidize and consume the reductive formic acid in time, and will not cause negative effects in acidic etching production. The alkaline regenerated etching replenishment solution prepared from filtrate A contains ammonium formate, and when it is reused in alkaline etching production, ammonium formate has no negative effect on the chemical reactions of alkaline etching.

Preferably, when the acidic pH value adjusting agent includes carbon dioxide, carbon dioxide is firstly used to adjust the pH of the alkaline PCB copper chloride etching waste solution downward until a copper salt is precipitated and the resulting pH is greater than 7, and then at least one acidic pH value adjusting agent selected from the group consisting of PCB acid copper chloride etching waste solution, hydrochloric acid, and organic acid is used to further adjust the pH downward. More preferably, when using at least one acidic pH value adjusting agent selected from the group consisting of PCB acid copper chloride etching waste solution, hydrochloric acid, and organic acid to further adjust the pH value downward, the resulting pH value is not lower than 7, so as to generate as much copper salt precipitate as possible and avoid a large amount of carbon dioxide release that resulting in waste.

Preferably, the alkaline pH value adjusting agent is at least one selected from the group consisting of PCB alkaline cupric chloride ammonium etching waste solution, ammonia solution, ammonium carbonate, and ammonium bicarbonate. Because when the alkaline pH value adjusting agent comprises at least one selected from the group consisting of sodium hydroxide, potassium hydroxide, sodium carbonate, sodium bicarbonate, the resulting filtrate A will contain too many potassium ions and/or sodium ions, and thus most of the filtrate A needs to be discharged and cannot be reused in the etching production. Therefore, the preferred scheme of the alkaline pH value adjusting agent can reduce the use of inorganic base raw materials containing potassium or sodium as alkaline pH value adjusting agents, overcome the problem of difficulty to realize environmental protection recycling, and thereby improve the recycling rate.

More preferably, the alkaline pH value adjusting agent is solid ammonium carbonate, therefore minimizing the volume increase of the reaction solution during the pH adjusting process. The ammonium ions in the reaction solution increased by addition of solid ammonium carbonate can be removed in step (3), and the components in the solution can be easily balanced when it is subsequently prepared as a regenerated etching replenishment solution for reuse.

Whether the PCB copper chloride etching waste solution mentioned in step (1) is a mixture of the PCB acid copper chloride etching waste solution and the PCB alkaline copper chloride ammonia etching waste solution, or the PCB acid copper chloride etching waste solution and/or the PCB alkaline copper chloride ammonia etching waste solution are used as the pH value adjusting agent, the following reactions will occur during the mixing process:

CuCl₂+4NH₄OH→Cu(NH₃)₄Cl₂⬇+4H₂O;

2CuCl₂+3NH₄OH→Cu₂(OH)₃Cl⬇+3NH₄Cl;

CuCl₂+2NH₄OH→Cu(OH)₂⬇+2NH₄Cl;

4Cu(NH₃)₂Cl+6H⁺+4H₂O+O₂→2Cu₂(OH)₃Cl⬇+2NH₄Cl+6NH₄⁺;

2Cu(NH₃)₄Cl₂+5H⁺+3H₂O→Cu₂(OH)₃Cl⬇+3NH₄Cl+5NH₄⁺;
FeCl₃+3NH₄OH→Fe(OH)₃⬇+3NH₄Cl (when the PCB acid copper chloride etching waste solution contains iron ions);
FeCl₂+2NH₄OH→Fe(OH)₂⬇+2NH₄Cl (when the PCB acid copper chloride etching waste solution contains iron ions).

When the PCB copper chloride etching waste solution mentioned in step (1) is alkaline, the chemical reactions that occur during neutralization with an acidic pH value adjusting agent are as follows. The hydrogen ions in the following reaction equations are from the acidic pH value adjusting agent.

4Cu(NH₃)₂Cl+6H⁺+4H₂O+O₂→2Cu₂(OH)₃Cl ⬇+2NH₄Cl+6NH₄⁺;

2Cu(NH₃)₄Cl₂+5H⁺+3H₂O→Cu₂(OH)₃Cl⬇+3NH₄Cl+5NH₄⁺.

When the PCB copper chloride etching waste solution mentioned in step (1) is acidic, the chemical reactions that occur during neutralization with sodium hydroxide and/or potassium hydroxide and/or ammonia and/or ammonium hydroxide of an alkaline pH value adjusting agent are as follows.

H⁺+OH⁻→H₂O;

CuCl₂+2OH⁻→Cu(OH)₂⬇+2Cl⁻;

2CuCl₂+3OH⁻→Cu₂(OH)₃Cl+3Cl⁻;

FeCl₃+3OH⁻→Fe(OH)₃⬇+3Cl⁻ (when the PCB copper chloride etching waste solution contains iron ions);

FeCl₂+2OH—→Fe(OH)₂⬇+2Cl⁻ (when the PCB copper chloride etching waste solution contains iron ions);

CuCl₂+4NH₄OH→Cu(NH₃)₄Cl₂⬇+4H₂O (when the pH value adjusting agent contains ammonia and/or ammonium hydroxide).

When the PCB copper chloride etching waste solution mentioned in step (1) is acidic, the chemical reactions that occur during neutralization with carbonate salt and/or bicarbonate salt of an alkaline pH value adjusting agent are as follows.

### (i) Carbonate Salt

2H⁺+CO₃²⁻→H₂O+CO₂⬆;

CuCl₂+2CO₃²⁻+2H⁺→Cu(OH)₂⬇+2Cl⁻+2CO₂⬆;
FeCl₃+3CO₃²⁻+3H⁺→Fe(OH)₃⬇+3Cl⁻+3CO₂⬆ (when the PCB copper chloride etching waste solution contains iron ions);
FeCl₂+2CO₃²⁻+2H⁺→Fe(OH)₂⬇+2Cl⁻+2CO₂⬆ (when the PCB copper chloride etching waste solution contains iron ions).

### (ii) Bicarbonate Salt

H⁺+HCO₃⁻→H₂O+CO₂⬆;

CuCl₂+2HCO₃⁻→Cu(OH)₂⬇+2Cl⁻+2CO₂⬆;
FeCl₃+3HCO₃⁻→Fe(OH)₃⬇+3Cl⁻+3CO₂⬆ (when the PCB copper chloride etching waste solution contains iron ions);
FeCl₂+2HCO₃⁻→Fe(OH)₂⬇+2Cl⁻+2CO₂⬆ (when the PCB copper chloride etching waste solution contains iron ions).

When the PCB copper chloride etching waste solution mentioned in step (1) is acidic, and it is mixed with the alkaline pH value adjusting agent to neutral or alkaline, copper carbonate and/or basic copper carbonate precipitates can be produced in the solution by further adding carbonate and/or bicarbonate of the alkaline pH value adjusting agent.

CuCl₂+CO₃²⁻→CuCO₃⬇+2Cl⁻;

CuCl₂+2HCO₃⁻→CuCO₃+2Cl⁻+H₂O+CO₂⬆;

2CuCl₂+4HCO₃⁻→Cu₂(OH)₂CO₃+H₂O+4Cl⁻+3CO₂⬆.

Since at least one selected from the group consisting of the PCB copper chloride etching waste solution and the pH value adjusting agent contains ammonium and/or ammonia, the filtrate A obtained in step (2) mainly contains an ammonium salt and a chloride salt, and may also contain an inorganic acid or ammonium hydroxide, other components originally from the PCB copper chloride etching waste solution, and copper ammonia complex and/or soluble copper salt. The main component of the filter residue C obtained in step (2) includes at least one selected from the group consisting of ammonium cupric chloride, basic copper chloride, copper hydroxide, copper carbonate, and basic copper carbonate, and also includes ammonium salt and/or ammonium hydroxide and/or copper ammonium complex. When the PCB copper chloride etching waste solution and/or the pH value adjusting agent contain the PCB acid copper chloride etching waste solution with iron ions, the filtrate A may also contain an iron salt, and the filter residue C may also contain an iron hydroxide and/or an iron salt. The inventor found that although the new ammonium salt and/or chloride salt were generated in step (1), a considerable part of the soluble salt in the solution was wrapped and taken away by solid precipitation during SLS in step (2), so the chloride salt and the ammonium salt in filtrate A did not need to be discarded in large quantities due to excessive amounts.

The ammonia nitrogen removal treatment mentioned in step (3) applies at least one of the following approaches: (i) mixing the filter residue C with an ammonia nitrogen removal oxidant to perform oxidation reaction for ammonia nitrogen removal; (ii) direct heating for oxidation treatment on the filter residue C to remove ammonia.

### (i) Oxidation Reaction for Ammonia Nitrogen Removal

The ammonia nitrogen removal oxidant is a hypochlorite salt and/or chlorine gas, and the ammonium salt and/or ammonia in the filter residue C are removed by utilizing the oxidizing ability of a hypochlorite salt and/or chlorine gas, and nitrogen gas is generated during the reaction. The hypochlorite salt is specifically potassium hypochlorite and/or sodium hypochlorite.

The mixture obtained after the ammonia nitrogen removal treatment is separated into solid and liquid to obtain filtrate B and filter residue D. The filtrate B contains a chloride salt and/or a hypochlorite salt and/or an inorganic base, and the main component of the filter residue D is copper hydroxide and/or copper carbonate and/or copper oxide and/or a percuprate salt. When the filter residue C contains an iron hydroxide and/or an iron salt, the iron-containing components therein will also exist in the filter residue D in the form of an iron hydroxide and/or an iron oxide, and/or exist in the filtrate B in the form of an iron salt and/or a ferrate salt. The components and their proportions of in the obtained filter residue D can be controlled during the chemical reaction by the pH value of the reaction solution, the working temperature, the oxidation-reduction potential (ORP) parameter value, the reaction time, and the ammonia and/or ammonium concentration in the reaction solution at the end of the reaction. And when the obtained filtrate B contains surplus ammonia nitrogen removal oxidant the hypochlorite salt and inorganic base, it can be used for oxidation treatment in other processes.

At least one of the following chemical reactions occurs during the ammonia nitrogen removal reaction:
(1) When the ammonia nitrogen removal oxidant contains a hypochlorite salt

Cu(NH₃)₄Cl₂+6ClO⁻→2HCl+6Cl⁻+CuO⬇+2N₂⬆+5H₂O;

2Cu₂(OH)₃Cl+3ClO⁻+2NH₄Cl→4HCl+3Cl⁻+4CuO⬇+N₂⬆+5H₂O;

(2) When the ammonia nitrogen removal oxidant contains chlorine gas

Cu(NH₃)₄Cl₂+6Cl₂+H₂O→14HCl+CuO⬇+2N₂⬆;

Cu₂(OH)₃Cl+2NH₄Cl+3Cl₂→9HCl+2CuO⬇+N₂⬆+H₂O;

Wherein, chlorine gas dissolves in water to generate a hypochlorite salt and chloride ions, so when the ammonia nitrogen removal oxidant contains chlorine gas, the same reaction as when the ammonia nitrogen removal oxidant contains a hypochlorite salt will also occur. When the reaction mixture is alkaline and the ammonia nitrogen removal oxidant contains chlorine gas, the reaction of chlorine gas with the alkaline substance may also produce chlorate ions.

When the filter residue C contains a ferrous salt and/or ferrous hydroxide, at least one of the following reactions will also occur during the ammonia nitrogen removal reaction.

6Fe²⁺+3ClO⁻+3H₂O→2Fe(OH)₃+4Fe³⁺+3Cl⁻;

2Fe²⁺+Cl₂→2Fe³⁺+2Cl⁻;

6Fe(OH)₂+3ClO⁻+3H₂O→6Fe(OH)₃+3Cl⁻;

6Fe(OH)₂+3Cl₂→2Fe³⁺+4Fe(OH)₃+6Cl⁻.

The inventors found that when the pH value of the reaction mixture in the oxidation reaction for ammonia nitrogen removal is ≥6.8, the generation of dangerous and explosive nitrogen trichloride during the oxidation reaction for ammonia nitrogen removal in the recovery treatment can be avoided. And when hydroxide exists in the reaction mixture, it can effectively promote the removal reaction of ammonia and/or ammonium.

Therefore, as a preferred embodiment of the present disclosure: when the ammonia nitrogen removal oxidation reaction is adopted in step (3), supplementary inorganic base is added to the reaction mixture during the ammonia nitrogen removal treatment to maintain the pH value of the reaction solution at ≥6.8. More preferably, the pH value of the reaction solution is maintained at =7. The inorganic base is at least one selected from the group consisting of sodium hydroxide, potassium hydroxide, sodium carbonate, potassium carbonate, sodium bicarbonate, and potassium bicarbonate, preferably sodium hydroxide.

During the oxidation reaction for ammonia nitrogen removal process, adding supplementary inorganic base to the reaction mixture, or when the pH value of the reaction mixture itself is ≥7, at least one of the following reactions will occur.

2NH₄Cl+3ClO⁻+2OH⁻→5Cl⁻+N₂⬆+5H₂O;

2NH₃+3ClO⁻→3Cl⁻+N₂⬆+3H₂O;

2NH₄Cl+3Cl₂+8OH⁻→8Cl⁻+N₂⬆+8H₂O;

2NH₃+3Cl₂+6OH⁻→6Cl⁻+N₂⬆+6H₂O.

During the ammonia nitrogen removal oxidation reaction process, an alkaline pH value adjusting agent other than the PCB alkaline copper chloride ammonium etching waste solution is newly added, and the basic copper chloride, copper carbonate and basic copper carbonate in the filter residue C can be converted into copper hydroxide.

Cu₂(OH)₃Cl+OH⁻→Cl⁻+2Cu(OH)₂⬇;

CuCO₃+2OH⁻→Cu(OH)₂⬇+CO₃²⁻;

Cu₂(OH)₂CO₃+2OH⁻→2Cu(OH)₂⬇+CO₃²⁻.

After repeated experiments the inventors have found that when the basicity of the reaction mixture is high, it is easy to further oxidize cupric ions into a percuprate salt and oxidize ferric hydroxide into a ferrate salt during the ammonia nitrogen removal oxidation process.

2Cu(OH)₂+2OH⁻+ClO⁻→2CuO₂⁻+Cl⁻+3H₂O;

2CuO+2OH⁻+ClO⁻→2CuO₂−+Cl−+H₂O;
2Fe(OH)₃+OH⁻+3ClO⁻→2FeO₄²⁻+3HCl+2H₂O(when the reaction mixture contains ferric hydroxide).

Since percuprate salts are usually water-insoluble, whereas ferrate salts are soluble in water. Therefore, the ferric oxide and/or the ferric hydroxide in the reaction mixture can be oxidized to generate a soluble ferrate salt by reacting with the ammonia nitrogen removal oxidant under the condition of high basicity, so that the iron compound can be separated from the copper compound which is converted to the product sodium percuprate solid.

Preferably, when the filter residue C contains iron hydroxide, the ammonia nitrogen removal oxidation reaction is carried out at a higher reaction solution basicity, a higher reaction solution ORP value and a higher reaction temperature. More preferably, the pH value of the reaction mixture is controlled at ≥9 during the ammonia nitrogen removal process, and the reaction solution is heated and its ORP value is controlled at a higher value to promote the formation of percuprate and/or ferrate.

### (ii) Heating Oxidation Treatment for Ammonia Nitrogen Removal

During the reaction process of removing ammonia nitrogen by heating, copper oxide solids are generated, accompanied by hydrogen chloride gas and/or ammonia gas and/or carbon dioxide gas and/or water. When the filter residue C contains ammonium chloride, the sublimation reaction of ammonium chloride will also occur due to the temperature rise, so the tail gas needs to be absorbed.

At least one of the following chemical reactions occurs during the direct heating oxidation treatment for ammonia nitrogen removal process:

Cu(NH₃)₄Cl₂+H₂O→⁶⁶CuO+4NH₃⬆+2HCl⬆;

Cu₂(OH)₃Cl₂→ΔCuO+2HCl⬆+H₂O;

CuCl₂+H₂O→ΔCuO+2HCl⬆;

Cu(OH)₂→ΔCuO+H₂O;

CuCO₃→ΔCuO+CO₂⬆;

Cu₂(OH)₂CO₃→Δ2CuO+CO₂⬆+H₂O;

NH₄Cl→ΔNH₃⬆+HCl⬆;

NH₄Cl→ΔNH₄Cl⬆.

When the filter residue C contains an iron salt and/or an iron hydroxide, at least one of the following reactions will occur in the heating oxidation treatment for ammonia nitrogen removal to form an iron oxide.

2Fe(OH)₃→ΔFe₂O₃+3H₂O;

4Fe(OH)₂+O₂→Δ2Fe₂O₃+4H₂O;

2FeCl₃+3H₂O→ΔFe₂O₃+6HCl;

4FeCl₂+4H₂O+O₂→Δ2Fe₂O₃+8HCl.

Therefore, in step (3), the filter residue C is heated and oxidized for ammonia nitrogen removal to obtain a solid mainly composed of copper oxide, which may also contain iron oxide and/or a small amount of oxide impurities of other metals.

There is a difference between the crystal structure of iron oxide formed at high temperature in the heating oxidation treatment for ammonia nitrogen removal and the crystal structure of iron oxide formed at room temperature. The former is difficult to dissolve in sulfuric acid at room temperature. Taking advantage of the chemical specificity that the crystal structure of iron oxide formed at high temperature is only slightly soluble in sulfuric acid, the mixture of copper oxide and iron oxide obtained by the heating oxidation treatment for ammonia nitrogen removal in step (3) can be separated after dissolving copper oxide powder in sulfuric acid. Therefore, when the filter residue C contains an iron compound, it is preferable to apply the heating oxidation treatment for ammonia nitrogen removal in step (3).

In step (4), there are several approaches as follows:

(1) When reusing to the alkaline etching process only, take the filtrate A to prepare an alkaline regenerated etching replenishment solution according to the process requirements with at least one selected from the group consisting of ammonia solution, liquid ammonia, ammonium chloride, and other additives, and reuse it on the alkaline etching production line.
(2) When reusing to the acidic etching process only, take the filtrate A to prepare an acid regenerated etching replenishment solution and/or an acid etching oxidant and reuse them on the acid etching production line. At this time, according to the process conditions, the filtrate A is distributed for the reuse amount of the acid regenerated etching replenishment solution and the acid etching oxidant solution. During the preparation process, the filtrate A has its composition adjusted according to the process requirements and is reused in the acidic etching system as a regenerated etching replenishment solution. If the filtrate A is acidic, it can be used directly or after composition adjustment as an acidic regenerated etching replenishment solution for reuse in the acidic etching system; when the filtrate A is used to prepare an acidic etching oxidant and reused in the acidic etching system, the filtrate A is adjusted to neutral or basic condition and mixed with sodium chlorate and/or potassium chlorate to prepare a chemically stable solution mixture as an acidic etching oxidant.
(3) When reusing to both the acidic etching process and the alkaline etching process, according to the process requirements, the filtrate A is distributed according to the preparation requirements of the alkaline regenerated etching replenishment solution, acidic regenerated etching replenishment solution and/or acidic etching oxidant, and then used in the etching process directly or after composition adjustment as in the above-mentioned approaches (1) and (2) according to the process requirements.

This process method is based on the neutralization precipitation recovery process technology of the existing acid copper chloride etching waste solution and alkaline copper chloride etching waste solution, combining with the two above-mentioned ammonia nitrogen removal treatment processes as a process improvement, and can remove the ammonium salt in the copper sludge precipitate generated by the neutralization reaction in the existing process technology. Compared with the prior art, present disclosure's process scheme has the following four advantages:

First, it is suitable for PCB etching production enterprises that use both acidic etching and alkaline etching processes containing ammonium chloride components. The matching quantity of the acidic etching waste solution and the alkaline etching waste solutions is used for on-site on-line treatment to achieve 100% recycling. Among the copper hydroxide and/or copper carbonate and/or basic copper carbonate and/or copper oxide and/or sodium percuprate obtained after the ammonia nitrogen removal treatment in step (3), sodium percuprate can be reduced to obtain a copper oxide. Copper hydroxide, copper carbonate, basic copper carbonate, and copper oxide can all be converted into a copper salt product through a simple chemical reaction, and even further into electrolytic copper, or the obtained copper oxide can be directly used as a copper supplementary source in the acidic copper electroplating process, so that PCB manufacturers can turn copper-contained waste solution into copper source materials for recycling in production, and improve cost-effectiveness indicators and environmental governance indicators.

Second, with the improvement of the alkaline etching process of PCBs in the industry, a new type of weakly alkaline copper chloride ammonia etching process came out with an industrial control point of pH value close to the pH7 neutral point of the working etching solution, and its etching quality can be improved by 6 times compared with the current existing process. This kind of weakly alkaline cupric chloride ammonium etching waste solution is more suitable for the recycling method through precipitation treatment of the present disclosure that adding an acidic pH value adjusting agent. No new pollution sources due to the continuous increase in the volume of the reaction solution in the waste solution treatment will be generated and stop achieving 100% recycling.

Third, the new acidic etching solution contained both copper chloride and ferric chloride, or further contained ammonium chloride, has much better etching performance than the acid copper chloride etching process of the prior art. Its production efficiency can be increased by 1.6 times, and the etching quality can be increased by 30%, which make it more and more popular in the industry. After mixing the iron-containing acidic etching waste solution with the alkaline etching waste solution, the obtained filter residue C contains an iron compound. The present disclosure can effectively separate the copper compound and the iron compound to facilitate their respective recovery. It should be pointed out that since most of the iron sources on the current market usually contain heavy metal impurities such as manganese, so that the acidic etching waste solution containing iron often contains traces of manganese ions and other heavy metal ions. If the waste acidic etching solution containing iron is used in step (1), the filter residue C obtained in step (2) will also contain heavy metal impurities other than copper and iron. At this time, if approach (i) in step (3) is adopted, further impurity removal treatment is required to remove impurities, such as manganese in the iron compound product, from the mixture of a copper compound and an iron compound. By adopting the approach (ii) of step (3), the precipitated copper sludge contained metal element impurities such as iron and manganese can be converted into copper oxide, iron oxide and manganese dioxide after high temperature treatment. Copper oxide is easily soluble in sulfuric acid, whereas iron oxide and manganese dioxide after high temperature treatment are not easily soluble in sulfuric acid. So that utilizing the above-mentioned material characteristics, the filter residue C after high-temperature heating and oxidation treatment is mixed with a solution containing sulfuric acid, and a copper sulfate solution can be obtained after SLS. In addition, the iron oxide and manganese dioxide insoluble in sulfuric acid are separated and processed to obtain iron oxide with higher purity for recycling. Approach (ii) of step (3) does not need other additional impurity removal processes and equipment, and hence the production and recycling cost is reduced.

the present disclosure may be improved as follows: when the PCB copper chloride etching waste solution in step (1) contains alkaline etching waste solution, the alkaline etching waste solution is firstly heated to remove ammonia and then treated as part or all of the PCB copper chloride etching waste solution according to the present disclosure. This improvement can reduce the concentration of ammonia and/or ammonium in the alkaline etching waste solution, and subsequently reduce the amount required of the acidic pH value adjusting agent, thereby avoiding the generation of excessive ammonium chloride and too much filtrate A during the reaction in step (1), which cannot be recycled and lead to accumulation waste and environmental pollution, and facilitating the preparation of regenerated etching replenishment solution. Ammonia gas, water vapor and/or carbon dioxide gas escape during the process of heating for removing ammonia, and ammonia solution and/or water can be used for absorption to obtain a solution containing ammonium carbonate and/or ammonium bicarbonate and/or ammonia solution that can reused in the preparation of alkaline etching replenishment solution, or the solution in the preparation of alkaline regenerated etching replenishment solution is directly used for absorption.

Preferably, when the PCB copper chloride etching waste solution mentioned in step (1) contains PCB alkaline copper chloride ammonia etching waste solution, the PCB alkaline copper chloride ammonia etching waste solution is firstly heated to ≥ 55° C. for removing ammonia.

Preferably, the ammonia-containing tail gas released during heating for removing ammonia from the alkaline etching waste solution is led to the solution in the preparation of alkaline regenerated etching replenishment solution for absorption.

The present disclosure may also be improved as follows: before step (1), the acidic etching waste solution and/or the alkaline etching waste solution are subjected to water-oil separation and/or SLS treatment respectively, so that the photoresist residue and the solid impurities in the acidic etching waste solution are removed, and/or the photoresist residue, stannous hydroxide precipitate and other solid impurities in the alkaline etching waste solution are removed.

The present disclosure may also be improved as follows: in step (2) of the present disclosure, a removal treatment of chloride salt and/or separation treatment of metal impurities other than copper on the filter residue C is additionally adopted.

The present disclosure may also be improved as follows: when the approach (i) is adopted in step (3) of the present disclosure, the adding amount of the ammonia nitrogen removal oxidant is controlled according to the ORP parameter value of the reaction solution to adjust the ammonia nitrogen removal reaction speed, the adding amount of the inorganic base is controlled according to the pH parameter value of the reaction solution, and the temperature and the reaction time of the reaction solution are controlled so that the concentration of ammonia or ammonium salt in the reaction solution meets the process requirements after treatment.

The present disclosure may also be improved as follows: when the approach (i) is adopted in step (3), the chlorine gas produced by the chlorine gas generator that applies electrolysis is selected as the ammonia nitrogen removal oxidant, replacing the hypochlorite salt solution and chlorine gas purchased from the market. It can optimize the control of the ammonia nitrogen removal oxidation process without introduction of new impurities, which is beneficial to recycling and reuse and hence reduce production costs, and can reduce the water brought in so that the discharge amount of the waste solution of filtrate B can reduced.

The present disclosure may also be improved as follows: when the approach (i) is adopted in step (3), use hydrogen peroxide and/or sodium sulfite solution and/or sodium bisulfite to occur reduction reaction with sodium percuprate in the obtained filter residue D to obtain copper oxide. The obtained copper oxide is washed with clean water to remove the chloride salt, sodium ions and potassium ions therein to obtain copper oxide with higher purity for recycling.

The chemical reaction principle of the reduction reaction of sodium percuprate to form copper oxide is as follows:

2NaCuO₂+Na₂SO₃+H₂O→2CuO+Na₂SO₄+2NaOH;

2NaCuO₂+NaHSO₃+H₂O→2CuO+NaHSO₄+2NaOH;

2NaCuO₂+H₂O₂→2CuO+2NaOH+O₂⬆.

The present disclosure may also be improved as follows, using the filtrate B solution containing oxidant and/or hydrogen peroxide for chemically treatment of the hydrogen gas released from the chlorine gas generator that applies electrolysis, alleviating or even eliminating the harm of hydrogen gas.

The present disclosure may also be improved as follows: when the approach (ii) is adopted in step (3) of the present disclosure, the temperature for directly heating the filter residue C is not lower than 100° C., so as to obtain a good yield of copper oxide. When there are iron ions and manganese ions in the filter residue C, use a higher heating temperature for the filter residue C with addition of oxygen gas or air in the heating reaction, which will help to convert the iron ions and manganese ions into iron oxide and manganese dioxide.

The present disclosure may also be improved as follows: when the approach (ii) is adopted in step (3), the filter residue C is mechanically pulverized at high temperature during the direct heating oxidation process, and/or the filter residue C is oxidized by alternating heating oxidation→cooling pulverization→again heating oxidation. This improves the situation that the iron compound and manganese compound wrapped in the solid copper precipitation are difficult to carry out oxidation reaction, and the improved process can further increase the reaction yield of formation of high temperature iron oxide and manganese dioxide.

Preferably, while the filter residue C is alternately heating oxidized and cooling pulverized in step (3), it is washed with water after mechanical pulverization to remove the ammonium salt and/or soluble salt impurities such as sodium salt and potassium salt originally contained in the filter residue C. By washing with water before heating oxidization, the copper compound and the iron compound can be obtained with higher purity.

The present disclosure may also be improved as follows: when the approach (ii) is adopted in step (3) of the present disclosure, the recovered iron oxide is reused in the acidic etching process as an iron source material.

The present disclosure may be improved as follows: when the filtrate A contains an iron salt, the newly prepared alkaline regenerated etching replenishment solution in step (4) is precisely filtered before use to remove iron hydroxide solids therein.

The present disclosure may also be improved as follows: control the reaction temperature of the reactants during the reaction process of step (1) and/or step (3), and/or lower the temperature of filtrate A before step (4). The latter enables the filtrate A to precipitate more salt to solid by lowering the temperature, so that the filtrate A is more in line with the process requirements to prepare a recycled etching solution.

The present disclosure may also be improved as follows: the filtrate A is heated, evaporated and concentrated by an evaporator before step (4), so that the filtrate A can ensure 100% recycling while reducing the volume of the solution, and there is no new pollution source caused by too much waste solution that cannot be reused.

The second objective of the present disclosure is to provide an apparatus for recycling of PCB copper chloride etching waste solution through precipitation treatment, which is assembled from the following equipment components. It mainly includes:
At least one reaction tank or its combination with at least one solid heating device, at least one solid-liquid separator, and at least one temporary storage tank. Wherein, at least two selected from the group consisting of the reaction tank, the solid-liquid separator and the temporary storage tank are connected through a pipeline or through a pipeline provided with a pump and/or a valve;

The reaction tank is used for mixing the PCB copper chloride etching waste solution and the pH value adjusting agent to react and form a copper sludge precipitate, and/or for mixing the precipitated copper sludge and the ammonia nitrogen removal oxidant to carry out the ammonia nitrogen removal oxidation reaction of the approach (i) in step (3).

The solid heating device is used for high-temperature direct heating oxidation on the copper sludge or copper slag obtained from the solid-liquid separator for ammonia removal treatment of the approach (ii) in step (3).

The solid-liquid separator is used for SLS of solid-liquid mixture.

The temporary storage tank is used for solution storage and/or preparation of etching replenishment solution.

The solid heating device can be an electric heating device, or a heating device that applies combustion oxidation reaction.

Preferably, the solid-liquid separator can be selected from a filter, or a rotary centrifuge, or a filter press.

Preferably, a detection device is further provided respectively in a reaction tank, a solid-liquid separator, a temporary storage tank, inner space of a connecting pipeline and production workshop area. The detection device includes one or a combination of two or more selected from the group consisting of a gravimeter, a colorimeter, a pH meter, an acidity meter, an ORP meter, a thermometer, a liquid-level meter, a flow meter, a chlorine gas detector, and a hydrogen gas detector according to the process control requirements.

Preferably, a stirring device is further included inside a reaction tank and/or a temporary storage tank, and the stirring device can be one or a combination of two or more selected from the group consisting of a liquid circulator, a paddle stirring device, a gas inductor, which can be used for stirring according to the process requirements.

Preferably, a heat exchange device is further provided to a reaction tank and/or a temporary storage tank to cool down or heat up the solution in the reaction tank and/or the temporary storage tank. The heat exchange device can also be used under process control for salt crystallization from the reaction solution with temperature cooling, so that the solution obtained after filtration of the reaction solution is more suitable for preparing a recycling etching solution.

Preferably, a feed port, a discharge port, an overflow port and a gas outlet are provided in a reaction tank and/or a temporary storage tank, so that the equipment structure can meet various technical requirements of the process, and the gas produced during the production process can be easily collected and treated.

The present disclosure may be improved as follows: a heating reactor is further provided, so that an alkaline etching waste solution can be heated for removing ammonia.

The present disclosure may also be improved as follows: a concentrating evaporator for aqueous solution is further provided, so that the filtrate A can be heated, concentrated and evaporated to reduce its volume.

The present disclosure may be improved as follows: a pulverizer is further included to pulverize and/or grind the copper sludge that has been heat-treated at high temperature.

The present disclosure may be improved as follows: a water-oil separator and/or a filter is further provided to remove impurities from an etching waste solution, or a pH value adjustment agent solution, or a recycled solution.

The present disclosure may also be improved as follows: a tail gas treating device is further provided, and the tail gas treating device can be one or a combination of two selected from a vacuum jetting gas-liquid mixing device and a spraying tower gas-liquid mixing device, which can be used for tail gas treating according to the process requirements. And the tail gas can be classified according to its temperature and chemical properties and treated in a tail gas treating device.

The present disclosure may also be improved as follows: a washing tank with a stirring device is further provided to wash and purify the copper sludge produced in the recovery process or the copper sludge after heat-treatment.

The present disclosure may also be improved as follows: a chlorine gas generator that applies electrolysis is further provided to generate chlorine gas as an ammonia nitrogen removal oxidant, so as to optimize safety control and reduce production cost in the ammonia nitrogen removal oxidation process, and reduce wastewater discharge at the same time.

The chlorine gas generator that applies electrolysis is an electrolytic cell separated to at least one anode chamber and at least one cathode chamber, and chlorine gas is produced by electrolytic reaction of a chloride salt solution or an acid copper chloride etching waste solution, and the chlorine gas is used for ammonia nitrogen removal oxidation reaction.

Preferably, when a chlorine gas generator that applies electrolysis is used to obtain an ammonia nitrogen removal oxidant, the reaction tank for the ammonia nitrogen removal oxidation reaction is further provided with a vacuum jetting gas-liquid mixing device and/or a spraying tower gas-liquid mixing device, so as to better lead the chlorine gas from the chlorine gas generator that applies electrolysis to the reaction tank to participate in the ammonia nitrogen removal oxidation reaction.

The present disclosure may also be improved as follows: an automatic detection and feeding controller is further provided, so that the field data measured by each detection device is sent to the automatic detection and feeding controller for processing, thereby controlling the addition of materials during the reaction process, and/or adjusting the working output current of the electrolysis power supply of the chlorine gas generator that applies electrolysis according to the status of the ammonia nitrogen removal oxidation reaction to control the amount of chlorine gas generated, and perform a safety interlock for the electrolysis of chlorine gas. In addition, process control in temperature of the solid heating device can be adopted to achieve safe treatment of the tail gas from the solid heating device. So that the production process of the whole apparatus can achieve automatic safety control.

The present disclosure may also be improved as follows: an overflow tank is further provided, and the overflow tank is connected through a pipeline to at least one selected from the group consisting of a reaction tank, a solid-liquid separator, a temporary storage tank, and a chlorine generator that applies electrolysis, or is placed below the overflow port of at least one container selected from the group consisting of a reaction tank, a solid-liquid separator, a temporary storage tank, and a chlorine generator that applies electrolysis, so that the solution can flow according to the process requirements under the condition that the liquid level difference exists between the containers in the apparatus of the present disclosure.

The present disclosure may also be improved as follows: a normal-pressure tank sealing cover is further provided to cover and seal the tank in need in order to reduce material loss and environmental pollution.

The present disclosure may also be improved as follows: a hydrogen eliminator is further provided to eliminate the hydrogen gas electrolyzed by the chlorine gas generator that applies electrolysis, so as to eliminate the source of danger generated in the production.

Compared with the prior art, the present disclosure has the following beneficial effects:
1. The method of the present disclosure is safe, simple and reliable, and can be used for on-site real-time treatment of either acid copper chloride etching waste solution or alkaline copper chloride ammonia etching waste solution alone, and can also be used for on-site recovery and recycling treatment of a mixture of acid copper chloride etching waste solution and alkaline copper chloride ammonia etching waste solution;
2. The method of the present disclosure only needs simple devices including mixing device, Solid-liquid separator, reaction tank and/or heating tank to achieve the purpose of the present disclosure. These devices are simple in structure, easy to maintain, and their cost is far lower than expensive electrolysis equipment. Therefore, the equipment investment scale is small, the daily maintenance cost is low, and the economic benefit is high;
3. During the treatment process of the present disclosure, ammonium salt is generated after the copper ammonium complex in the waste solution is destroyed, and there is no generation of a large amount of free ammonia, so severe volatilization of ammonia is effectively avoided, and the environmental pollution is reduced;
4. The recycling process of the present disclosure has low energy consumption, no new pollution sources, and the solution obtained after copper salt precipitation can be recycled without affecting the efficiency and quality of etching production, thereby effectively improving production income and even realizing 100% recycling, which meets the requirements of current environmental protection regulations and emission reduction policies;
5. For the acid copper chloride etching waste solution containing ammonium chloride, the method of the present disclosure has both avoided the ammonium salt impurity in the copper precipitate obtained via the alkalization method, and the safety problem of producing nitrogen trichloride when adopting the electrolysis method;
6. When the etching waste solution contains iron components, the method of the present disclosure can separate and collect the copper compound and the iron compound in the waste solution.

7. The copper hydroxide and/or copper oxide product obtained by the method of the present disclosure can replace phosphorus copper and be used in the acid copper electroplating process in PCB production, so that production enterprises can turn waste into wealth through the treatment of copper-containing etching waste solution, and at the same time, the three major pollution sources of heavy metals, ammonia nitrogen and phosphorus can be solved, which has positive effect on environmental protection.

### BRIEF DESCRIPTION OF DRAWINGS

FIG. 1 shows the apparatus for recycling of PCB copper chloride etching waste solution through precipitation treatment used in Example 1 of the present disclosure;

FIG. 2 shows the apparatus for recycling of PCB copper chloride etching waste solution through precipitation treatment used in Example 2 of the present disclosure;

FIG. 2A is the partial enlarged view of zone 2-A in FIG. 2;

FIG. 2B is the partial enlarged view of zone 2-B in FIG. 2;

FIG. 2C is the partial enlarged view of zone 2-C in FIG. 2;

FIG. 2D is the partial enlarged view of zone 2-D in FIG. 2;

FIG. 2E is the partial enlarged view of zone 2-E in FIG. 2;

FIG. 3 shows the apparatus for recycling of PCB copper chloride etching waste solution through precipitation treatment used in Example 3 of the present disclosure;

FIG. 3A is the partial enlarged view of zone 3-A in FIG. 3;

FIG. 3B is the partial enlarged view of zone 3-B in FIG. 3;

FIG. 3C is the partial enlarged view of zone 3-C in FIG. 3;

FIG. 3D is the partial enlarged view of zone 3-D in FIG. 3;

FIG. 3E is the partial enlarged view of zone 3-E in FIG. 3;

FIG. 3F is the partial enlarged view of zone 3-F in FIG. 3;

FIG. 4 shows the apparatus for recycling of PCB copper chloride etching waste solution through precipitation treatment used in Example 4 of the present disclosure;

FIG. 4A is the partial enlarged view of zone 4-A in FIG. 4;

FIG. 4B is the partial enlarged view of zone 4-B in FIG. 4;

FIG. 4C is the partial enlarged view of zone 4-C in FIG. 4;

FIG. 5 shows the apparatus for recycling of PCB copper chloride etching waste solution through precipitation treatment used in Example 5 of the present disclosure;

FIG. 5A is the partial enlarged view of zone 5-A in FIG. 5;

FIG. 5B is the partial enlarged view of zone 5-B in FIG. 5;

FIG. 6 shows the apparatus for recycling of PCB copper chloride etching waste solution through precipitation treatment used in Example 6 of the present disclosure;

FIG. 6A is the partial enlarged view of zone 6-A in FIG. 6;

FIG. 6B is the partial enlarged view of zone 6-B in FIG. 6;

FIG. 6C is the partial enlarged view of zone 6-C in FIG. 6;

FIG. 6D is the partial enlarged view of zone 6-D in FIG. 6;

FIG. 6E is the partial enlarged view of zone 6-E in FIG. 6;

FIG. 6F is the partial enlarged view of zone 6-F in FIG. 6;

FIG. 7 shows the apparatus for recycling of PCB copper chloride etching waste solution through precipitation treatment used in Example 7 of the present disclosure;

FIG. 7A is the partial enlarged view of zone 7-A in FIG. 7;

FIG. 7B is the partial enlarged view of zone 7-B in FIG. 7;

FIG. 7C is the partial enlarged view of zone 7-C in FIG. 7;

FIG. 8 shows the apparatus for recycling of PCB copper chloride etching waste solution through precipitation treatment used in Example 8 of the present disclosure;

FIG. 8A is the partial enlarged view of zone 8-A in FIG. 8;

FIG. 8B is the partial enlarged view of zone 8-B in FIG. 8;

FIG. 8C is the partial enlarged view of zone 8-C in FIG. 8;

FIG. 8D is the partial enlarged view of zone 8-D in FIG. 8;

FIG. 8E is the partial enlarged view of zone 8-E in FIG. 8.

Reference numerals: 1 (mark 1-1 and 1-2 for more than one): reaction tank; 2 (mark 2-1 and 2-2 for more than one): solid heating device; 3 (mark 3-1 to 3-5 for more than one): solid-liquid separator; from 8 to 18: temporary storage tank; from 19 to 20: water oil separator; from 21 to 23: vacuum jetting gas-liquid mixing device; from 24 to 26: spraying tower gas-liquid mixing device; from 27 to 28: paddle stirring device; 29: liquid circulator; 30: gas inductor; from 31 to 32: heat exchange device; 33: chlorine gas generator that applies electrolysis; 34: anode chamber; 35: cathode chamber; 36: electrolysis power supply; 37: electrolytic cell separator; 38: automatic detection and feeding controller; from 39 to 55: detection device; from 56 to 84: valve; 85: sodium hydroxide; 86: sodium hydroxide solution; 87: potassium hydroxide; 88: potassium hydroxide solution; 89: potassium carbonate; 90: sodium carbonate; 91: sodium bicarbonate; 92: potassium bicarbonate; 93: sodium hypochlorite solution; 94: potassium hypochlorite solution; 95: chlorine gas; 96: copper hydroxide; 97: filtrate A; 98: filtrate B; 99: filter residue C; 100: filter residue D; 101: ammonium chloride; 102: ammonia solution; 103: additive; 104: water; 105: acidic regenerated etching replenishment solution; 106: alkaline regenerated etching replenishment solution; 107: acidic etching production line; 108: alkaline etching production line; from 109 to 110: washing tank with a stirring device for copper sludge; 111: hydrochloric acid; 112: acid copper chloride etching waste solution; 113: alkaline copper chloride ammonia etching waste solution; from 114 to 117: sealing tank cover; 118: sodium chloride solution; 119: potassium chloride solution; from 120 to 126: overflow tank with a pump and a valve; from 127 to 130: solid feeder; 131: conveyor belt; 132: liquid ammonia; 133: sulfuric acid solution; from 136 to 139: filtering device; from 140 to 141: pulverizer; 142: formic acid; 143: air; 144: sodium chlorate; 145: potassium chlorate; 146: acidic etching oxidant solution; 147: combustible gas; from 148 to 150: copper slag after heat treatment; 151: copper sulfate solution; 152: iron oxide powder; 153: sodium chloride solid; 154: ammonium carbonate; 155: ammonium bicarbonate; 156: chemical reactor; 157: hydrogen peroxide; 158: sodium sulfite solution; 159: sodium bisulfite; 160: hydrogen eliminator; 161: copper oxide; from 162 to 163: tail gas treating device; 164: heating reactor for removing ammonia from an alkaline etching waste solution; 165: concentrating evaporator for aqueous solution; 166: electroplating copper brightening agent; from 167 to 169: liquid circulator; from 170 to 200: pump; 201: carbon dioxide source; 202: carbon dioxide.

### DETAILED DESCRIPTION

The present disclosure is further described below through specific examples.

In the following examples of the present disclosure, the 1 m³ reaction tank, the temporary storage tank, the stirring device, the vacuum jetting gas-liquid mixing device, the spraying tower gas-liquid mixing device, the heating reactor for removing ammonia, the concentrating evaporator for aqueous solution, and the chlorine gas generator that applies electrolysis all are manufactured by Guangdong Foshan Yegao Environmental Protection Equipment Manufacturing Co., Ltd. The detection device, the solid heating device, the pump, the valve, and the PLC controller are commercially available products. The chemical raw materials used are all commercially available chemical raw materials. Other products with similar properties to the products listed above in the present disclosure may also be adopted by those skilled in the art according to conventional selection, which all can achieve the objectives of the present disclosure.

### Example 1

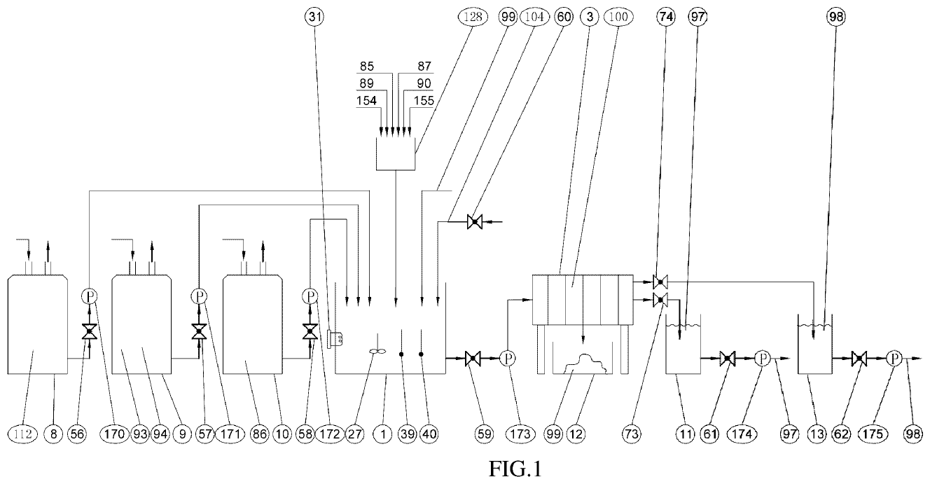

As shown in FIG. 1, an apparatus for recycling of PCB copper chloride etching waste solution through precipitation treatment is provided in this example, including a reaction tank 1, a solid-liquid separator 3, temporary storage tanks numbered from 8 to 13, a heat exchange device 31.

A paddle stirring device 27, the heat exchange device 31, detection devices 39 and 40 (specifically a pH meter and an ORP meter) are installed respectively in the reaction tank 1, and the tank is connected to the solid-liquid separator 3 through a pipeline provided with valve 71 and pump 56;

The solid-liquid separator 3 adopts common filter press;

The temporary storage tank 8 is used for storing acid copper chloride etching waste solution 112, and the temporary storage tank 9 is used for storing a mixed solution of sodium hypochlorite solution 93 and potassium hypochlorite solution 94 as an ammonia nitrogen removal oxidant, the temporary storage tank 10 is used for storing sodium hydroxide solution 86, the temporary storage tank 11 is used for storing filtrate A 97 from the solid-liquid separator 3, the temporary storage tank 12 is used for storing filter residue C 99 from the solid-liquid separator 3, and the temporary storage tank 13 is used for storing filtrate B 98 from the solid-liquid separator 3.

A solid feeder 128 is also provided, wherein a solid mixture of sodium hydroxide 85, potassium hydroxide 87, potassium carbonate 89, sodium carbonate 90, ammonium carbonate 154, and ammonium bicarbonate 155 is loaded.

The pipeline for water 104 is provided above the reaction tank 1.

The etching waste solution to be treated was the acid copper chloride etching waste solution 112 whose acidity was 2M, its main components were hydrochloric acid and copper chloride, and it was an aqueous solution containing ammonium chloride and sodium chloride additives. The approach (i) was adopted in step (3).

The treatment process was to firstly turn on the pump 170 to pump the acid copper chloride etching waste solution in the temporary storage tank 8 into the reaction tank 1, and turn on the paddle stirring device 27 and the heat exchange device 31. The pH of the reaction solution in the reaction tank 1 was controlled by the detection device 39 (specifically a pH meter) during the process, and the process set value of the pH meter in step (1) was pH5.5. That is, the pH meter controlled the solid feeder 128 to add alkaline pH value adjusting agents including sodium hydroxide 85, potassium hydroxide 87, potassium carbonate 89, sodium carbonate 90, ammonium carbonate 154, and ammonium bicarbonate 155 to the reaction tank 1, so that the pH of the reaction solution reached pH 5.5 and precipitation was occurred. After the reaction solution reached the process index, the paddle stirring device 27 was shut down and the reaction solution obtained after neutralization was subjected to cold precipitation through the heat exchange device 31. After, the valve 59 was opened and the pump 173 was turned on to pump the solid-liquid mixture in the reaction tank 1 to the solid-liquid separator 3 (specifically a filter press) for SLS, and the filtrate A was led to the temporary storage tank 11. When the mixture in the reaction tank 1 was completely pumped out, the valve 59 and the pump 173 were closed. The filter residue C was collected in the temporary storage tank 12 by opening the solid-liquid separator 3 (specifically a filter press), and its main components were copper hydroxide and basic copper chloride, and the impurities included soluble chloride salts and copper chloride ammonium complexes. The plate-and-frames of the solid-liquid separator 3 (specifically a filter press) were closed again after collecting the filter residue C solid, and waited for the next filtering operation.

The filter residue C which is a solid of copper hydroxide and basic copper chloride in the temporary storage tank 12 was put back into the reaction tank 1, and the valve 60 was opened to introduce water 104 into the reaction tank 1. The paddle stirring device 27 was turned on, the detection device 39 and 40 (specifically a pH meter and an ORP meter) worked simultaneously, and the detection device 40 (specifically an ORP meter) controlled the metering pump 171 to pump the ammonia nitrogen removal oxidant solution in the temporary storage tank 9 into the reaction tank 1. The set value of the ORP meter in process control was above 450 mV. Before addition of the ammonia nitrogen removal oxidant solution, the NH⁴⁺ concentration of the reaction solution in the reaction tank 1 was detected, and the detected concentration was 5 g/L. The valves 57 and 58 were opened, the pumps 171 and 172 pumped the sodium hydroxide solution 86 and the ammonia nitrogen removal oxidant in the tank 10 into the reaction tank 1, the input amount of the sodium hydroxide solution 86 was controlled according to the process set value pH6.8 of the detection device 39 (specifically a pH meter) in step (3), and the ammonia nitrogen removal oxidant was added to maintain the ORP value of the reaction at 450 mV, and the temperature of the reaction solution was controlled at 30° C. by the heat exchange device. When the reaction solution reached the above three control indicators and after 14 hours of reaction time according to the process, the NH⁴⁺ ion concentration was detected to be 80 mg/L, then the ammonia nitrogen removal oxidation reaction was considered to be completed, and the valve 59 was opened and the pump 173 was turned on again to pump the solid-liquid mixture in the reaction tank 1 to the solid-liquid separator 3 (specifically a filter press) for SLS. The filtrate B 98 was transferred into the temporary storage tank 13, and the filter residue D 100 was left in the solid-liquid separator 3 (specifically a filter press). The filter residue D had undergone ammonia nitrogen removal treatment and most of the sodium chloride, ammonium chloride and cupric chloride ammonium complex impurities in the filter residue C were removed, obtaining copper hydroxide with high purity.

Part of the filtrate A 97 had its pH value adjusted followed by introduction of sodium chlorate and potassium chlorate solids to prepare an acidic etching oxidant to reuse in the acidic etching production line. The remaining filtrate A 97 was directly reused in the acid etching production line as an acidic regenerated etching replenishment solution.

The filtrate B was analyzed and found that 80 mg/L of ammonia nitrogen remained in it for subsequent treatment.

The solid-liquid separator 3 was opened to take out the filter residue D copper hydroxide for recycling.

A method for recycling of PCB copper chloride etching waste solution through precipitation treatment, including following steps:
(1) The PCB copper chloride etching waste solution with an acidity of 2M was reacted with the alkaline pH value adjusting agent which was a solid mixture of sodium hydroxide, potassium hydroxide, sodium carbonate, potassium carbonate, ammonium bicarbonate and ammonium bicarbonate until the pH value of the reaction solution reached pH5.5 and copper salt precipitated;
(2) The solid-liquid mixture obtained was separated after the reaction in step (1) to obtain the filtrate A and the filter residue C;
(3) The filter residue C was mixed with the solution of potassium hypochlorite and sodium hypochlorite as in the approach (i) to carry out the oxidation reaction for ammonia nitrogen removal. During the reaction, the sodium hydroxide solution 86 was added to the reaction tank through the feeding pump to maintain the pH value parameter of the reaction solution at pH=6.8, and the oxidant was added until the ORP of the reaction solution reached and remained above 450 mV, and the temperature was controlled at 30° C. for 14 hours to complete the reaction. After the reaction was completed, the solid-liquid mixture in the reaction tank 1 was subjected to SLS again to obtain the filtrate B and the filter residue D whose main component was copper hydroxide.
(4) Part of the filtrate A was taken to adjust its pH value, and was mixed with sodium chlorate and potassium chlorate to prepare an acidic etching oxidant solution, which was then used in the acidic etching production line. The remaining filtrate A was reused in the acid etching production line as the acid regenerated etching replenishment solution.

This example of the present disclosure is to illustrate the recycling process of acid copper chloride etching waste solution through neutralization with the alkaline pH value adjusting agents including sodium hydroxide, potassium hydroxide, sodium carbonate, potassium carbonate, ammonium carbonate, ammonium bicarbonate to produce copper sludge precipitation. The precipitated copper sludge was recovered by using the approach (i) of the ammonia nitrogen removal oxidation treatment in step (3). The filtrate A was used to prepare the regenerated etching replenishment solution and the acidic etching oxidant to achieve 100% recycling.

### Example 2

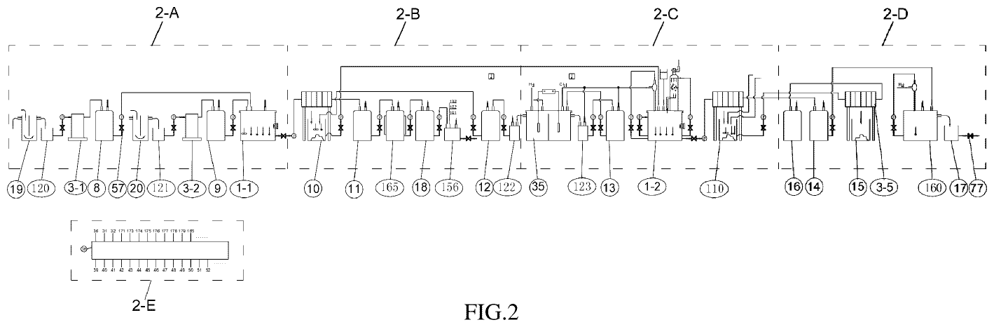

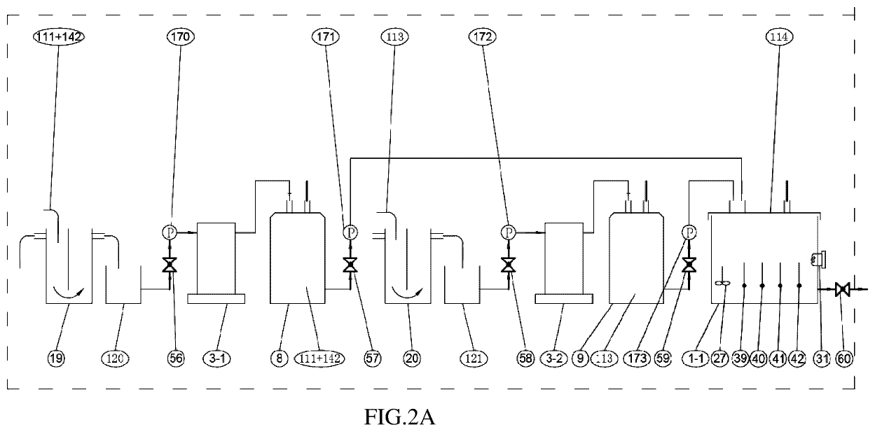

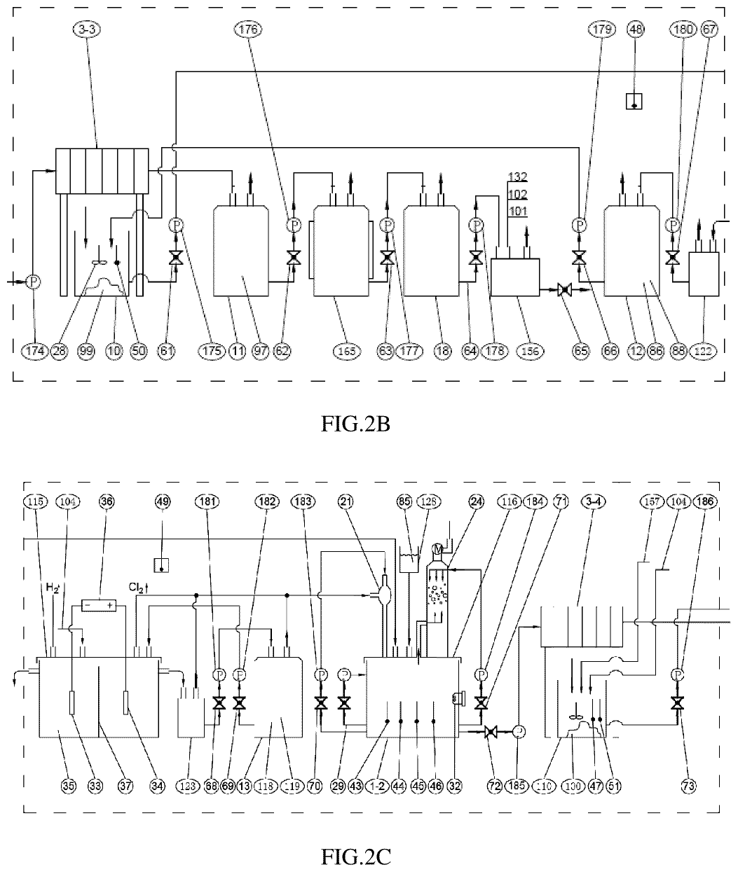

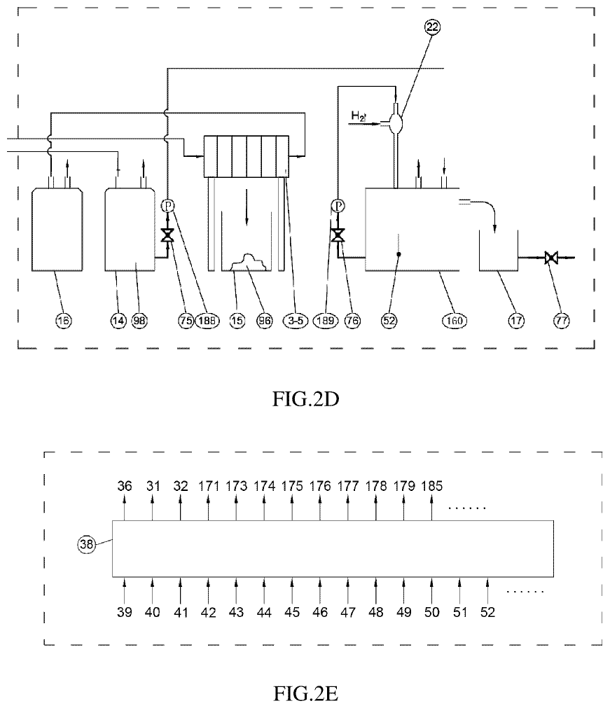

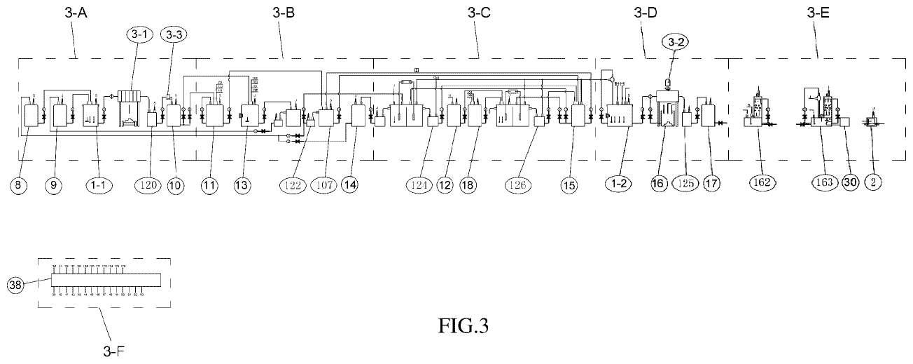

As shown in FIG. 2 and its partial enlarged view FIG. 2A, FIG. 2B, FIG. 2C, FIG. 2D and FIG. 2E, an apparatus for recycling of PCB copper chloride etching waste solution through precipitation treatment is provided in this example, including two reaction tanks, five solid-liquid separators, eight temporary storage tanks, two heat exchange devices, two water-oil separators, a solid feeder, a set of chlorine gas generator that applies electrolysis, a washing tank with a stirring device for copper sludge, fourteen detection devices and an automatic detection and feeding controller, a hydrogen eliminator, a chemical reactor 156, a set of concentrating evaporator for aqueous solution 165.

A paddle stirring device 27, a sealing tank cover 114, a heat exchange device 31, a detection device 39 (specifically a pH meter), a detection device 40 (specifically a gravimeter), a detection device 41 (specifically a thermometer), a detection device 42 (specifically a liquid-level meter) are installed in the reaction tank 1-1. The reaction tank 1-2 is equipped with a sealing tank cover 115, a liquid circulator 29, a heat exchange device 32, a vacuum jetting gas-liquid mixing device 21, a spraying tower gas-liquid mixing device 24, a detection device 43 (specifically a pH meter), a detection device 44 (specifically an ORP meter), a detection device 45 (specifically a thermometer), and a detection device 46 (specifically a liquid-level meter).

The solid-liquid separators 3-1 and 3-2 are ordinary filters with a filter medium structure, while the solid-liquid separators 3-3 to 3-5 are ordinary plate-and-frame filter presses.

The temporary storage tanks shown in FIG. 2 are used for temporary storage of different solution. Wherein a paddle stirring device 28 and a detection device 50 (specifically a liquid-level meter) are installed in the temporary storage tank 10.

The water-oil separators 19 and 20 and the solid-liquid separators 3-1 and 3-2 are used to respectively remove impurities from the acidic pH value adjusting agent and the alkaline cupric chloride ammonium etching waste solution. After impurity removal, the solutions were respectively transferred to temporary storage tanks 8 and 9 for storage.

The composition of the acidic pH value adjusting agent was a mixture of hydrochloric acid 111 and formic acid 142. The pH value of the alkaline copper chloride ammonia etching waste solution 113 to be treated is pH 8.3, and its main component is a mixture of ammonia solution, ammonium chloride and cupric chloride ammonia.

The concentrating evaporator for aqueous solution 165 is used for evaporating and concentrating the filtrate A in the temporary storage tank 11.

The solid feeder 128 is loaded with sodium hydroxide 85 to feed it into the reaction tank 1-2 to adjust the pH value of the ammonia nitrogen removal oxidation reaction solution.

The electrolytic cell separator 37 in the chlorine gas generator that applies electrolysis is a cation exchange membrane, a mixed solution of sodium chloride and potassium chloride was electrolyzed and chlorine gas 95, hydrogen, and a mixed solution of sodium hydroxide solution 86 and potassium hydroxide solution 88 were obtained. The electrolyzed hydrogen was introduced into the hydrogen eliminator 160 through the vacuum jetting gas-liquid mixing device 22 to react with the oxidant for safe treatment. The chlorine gas 95 was diverted into the reaction tank 1-2 to take part in the chemical reaction.

The automatic detection and feeding controller 38 obtains field data through multiple detection devices for automatic control of the production process of the whole apparatus.

The washing tank with a stirring device for copper sludge 110 is specially used for washing the filter residue D with water, and a detection device 47 (specifically a pH meter) and a detection device 51 (specifically a photoelectric colorimeter) are installed in the tank to detect the pH and copper salt concentration in the washing liquid, and perform impurity removal treatment on the copper hydroxide therein.

The process adopted the approach (i) in step (3), and the process steps including pumping the acidic pH value adjusting agent into the water-oil separator 19, pumping the alkaline copper chloride ammonia etching waste solution 113 to be treated into the water-oil separator 20, and pumping the acidic pH value adjusting agent into the temporary storage tank 8 and the alkaline copper chloride ammonia etching waste solution to be treated into the temporary storage tank 9 after impurity removal through filters 3 and 4 respectively. The pump 173 was turned on to pump the alkaline etching waste solution into the reaction tank 1-1 at a constant volume. The paddle stirring device 27 and the heat exchange device 31 were turned on. The temperature of the reaction solution was detected by a detection device 41 (specifically a thermometer), the copper ion concentration of the reaction solution was detected by a detection device 40 (specifically a gravimeter), together with a detection device 39 (specifically a pH meter) and a detection device 42 (specifically a liquid-level meter) were applied to detect the temperature, copper ion concentration, pH and liquid level of the reaction solution, and the on-site detection data was sent to the automatic detection and feeding controller 38 for processing and program execution. The control pump 171 was turned on according to the process program to add the acidic pH value adjusting agent into the solution in the reaction tank 1-1, in order to adjust and maintain the pH value at pH7.9 during the reaction. In the process, the heat exchange device 31 controlled the temperature of the reaction solution to normal temperature. When the detected result of the detection device 40 (specifically a gravimeter) reached the set value, the precipitation reaction was completed. The valve 60 was opened and the pump 174 was turned on to pump the solid-liquid mixture in the reaction tank 1-1 to the solid-liquid separator 5 (specifically a filter press) for SLS. When the solution in the reaction tank 1-1 is evacuated, the valve 60 was closed and the pump 174 was turned off. The filtrate A 97 was diverted to the temporary storage tank 11 for storage, and the filter residue C was retained in the solid-liquid separator 5 (specifically a filter press). After completing the reaction tank 1-1, the plate-and-frames of solid-liquid separator 5 (specifically a filter press) were opened and the filter residue C was transferred to the temporary storage tank 10. The main component of the filter residue C was copper chloride ammonium complex salt. The plate-and-frames of the solid-liquid separator 5 (specifically a filter press) were closed again to prepare for the next filtering operation. A mixed solution of sodium hydroxide solution 86 and potassium hydroxide 88 in the temporary storage tank 12 was added under control into the temporary storage tank 10 according to the detection device 50 (specifically a liquid-level meter), and the paddle stirring device 28 was turned on to make precipitate into a suspension solution. The ammonia nitrogen content of the suspension solution in the temporary storage tank 10 was analyzed. The NH⁴⁺ ion concentration was 15 g/L. By opening the valve 61 and turning on the pump 175, all the suspension solution in the temporary storage tank 10 was added to the reaction tank 1-2. When the solution in the temporary storage tank 10 was evacuated, the valve 61 was closed and the pump 175 was turned off. The pumps 183 and 184, and the liquid circulator 29 were turned on, and the jet pump 189 of the hydrogen eliminator 160 was turned on to allow the vacuum jetting gas-liquid mixing device 22 to generate a vacuum negative pressure to prepare for extracting the electrolytic hydrogen. The chlorine gas generator that applies electrolysis, the solid feeder 128 and the heat exchange device 32 were turned on to allow normal operation of the ammonia nitrogen removal reaction. In the process, the on-site detection data of the detection device 43 (specifically a pH meter), the detection device 44 (specifically an ORP meter), the detection device 45 (specifically a thermometer), the detection device 46 (specifically a liquid-level meter) and the detection device 47 (specifically an ORP meter) in the hydrogen eliminator 160 were sent to the automatic detection and feeding controller 38 for processing. The output current magnitude of the electrolytic power supply was adjusted by the automatic detection and feeding controller 38 according to the on-site ORP value and the on-site pH value of the solution during the oxidation reaction for ammonia nitrogen removal, in order to control the amount of electrolytic chlorine gas and the motion of the solid feeder 128. Simultaneously, the pump 188 was used for adding an oxidizing agent to the hydrogen eliminator 160 according to the data detected by the detection device 47. During the reaction in the reaction tank 1-2 according to the process, the ORP value was controlled to be above 850 mV, the pH value was controlled to be pH7.5, the temperature of the reaction solution was controlled at room temperature and was maintained for 36 hours, and the concentration of NH⁴⁺ ions after reaction was resulted to be 70 mg/L which was considered to be the completion of the reaction. The chlorine gas generator that applies electrolysis, the pumps 183 and 184, the liquid circulator 29 and the heat exchange device 32 were turned off, the valve 72 was opened and the pump 185 was turned on to pump the solid-liquid mixture in the reaction tank 1-2 into the solid-liquid separator 6 (specifically a filter press) for SLS, the filtrate B was directed into the temporary storage tank 14, and the filter residue D whose main component was copper hydroxide was left in the solid-liquid separator 6 (specifically a filter press). The valve 72 was closed and the pump 185 was turned off after the mixed liquid in the reaction tank 1-2 was pumped out. The plate-and-frames of the solid-liquid separator 6 (specifically a filter press) were opened, the filter residue D 100 was taken out and transferred into the washing tank with a stirring device for copper sludge 110, water 104 was added to the washing tank 110, the paddle stirring device in the tank was turned on for washing, the pH value of the washing liquid and the copper salt concentration in the solution were monitored according to the detected result of the detection device 47 (specifically a pH meter) and the detection device 51 (specifically a photoelectric colorimeter), and the valve 73 was opened and the pump 186 was turned on to pump the solid-liquid mixture in the washing tank 110 into the solid-liquid separator 7 (specifically a filter press) for SLS after meeting the washing requirements. Its filtrate was diverted back to the temporary storage tank 16 and waited to be treated, and the filter residue copper hydroxide 96 was left in the solid-liquid separator 7 (specifically a filter press). After the solid-liquid mixture in the tank 110 was pumped out, the valve 73 was closed and the pump 186 was turned off. The plate-and-frames of the solid-liquid separator 7 (specifically a filter press) were opened and the filter residue copper hydroxide 96 was taken out and stored in the temporary storage tank 15 for further recovery, and then the plate-and-frames were reclosed and prepared for the next operation.

The filtrate A was extracted from the temporary storage tank 11 and was pumped to the concentrating evaporator for aqueous solution 165 for concentration, and the distilled water could be collected and reused. According to the process requirements, the filtrate A was concentrated and the obtained concentrated solution was pumped by the pump 177 to the temporary storage tank 18 for temporary storage. The solution in the tank 18 was used for preparation of an alkaline regenerated etching replenishment solution in a chemical reactor 156, ammonium chloride solid was added to the concentrated solution of the filtrate A in the chemical reactor 156 to adjust the chloride ion concentration, liquid ammonia 132 and/or ammonia solution 102 was added to adjust the ammonia content of the alkaline regenerated etching replenishment solution 106, and the obtained alkaline regenerated etching replenishment solution was reused in the alkaline etching production line 108.

The ammonia nitrogen impurity content of the filtrate B was analyzed to be 70 mg/L. The solution in the temporary storage tank 14 waited for further treatment.

During the operation, the detection data of the workshop site was transmitted to the automatic detection and feeding controller 38 for processing through the detection device 48 (specifically a hydrogen gas detector) and the detection device 49 (specifically a chlorine gas detector), and was used as a safety interlock of the production system.

A method for recycling of PCB copper chloride etching waste solution through precipitation treatment, including following steps:
(1) The pH8.3 PCB alkaline copper chloride ammonia etching waste solution that had been pre-treated for impurity removal was mixed with the acidic pH value adjusting agent for acidification, until the pH value of the reaction solution reached pH7.9 and copper sludge was precipitated.
(2) The solid-liquid mixture obtained after the reaction in step (1) was subjected to SLS to obtain filtrate A and filter residue C.
(3) The filter residue C was mixed with the inorganic base solution and carried out the oxidation reaction for ammonia nitrogen removal treatment with chlorine gas. During this period, the pH value of the reaction solution was maintained at pH 7.5 by adding sodium hydroxide through the solid feeder, and the oxidant chlorine gas was added until the ORP value of the reaction solution reached and remained in the numerical range above 850 mV. The temperature of the reaction solution was at room temperature and the reaction was carried out for 36 hours, the solid-liquid mixture obtained after the reaction was subjected to SLS, obtaining the filtrate B and the filter residue D whose main component was copper hydroxide.
(4) The filter residue D obtained in step (3) was washed with water to obtain purified copper hydroxide recovery.
(5) The concentrated solution of the filtrate A has its composition adjusted and turned into an alkaline regenerated etching replenishment solution that was used in the alkaline etching production line.

This example of the present disclosure is to illustrate the recycling process of alkaline cupric chloride ammonium etching waste solution by applying an acidic pH value adjusting agent and through neutralization and copper sludge precipitation. And the chlorine gas was used as an oxidant under alkaline condition in the oxidation reaction for ammonia nitrogen removal of the suspension solution containing the precipitated copper sludge, and copper hydroxide was obtained from the oxidation reaction of the copper chloride ammonium complex. In the process of producing chlorine gas by electrolysis, the hydrogen gas electrolyzed by the electrolysis cathode was also led to the hydrogen eliminator for safety treatment. Another feature of this example was that the filtrate A produced in the neutralization reaction and copper sludge precipitation was heated, evaporated and concentrated to prepare a regenerated etching replenishment solution according to the process requirements and was then used in the alkaline etching production line.

### Example 3

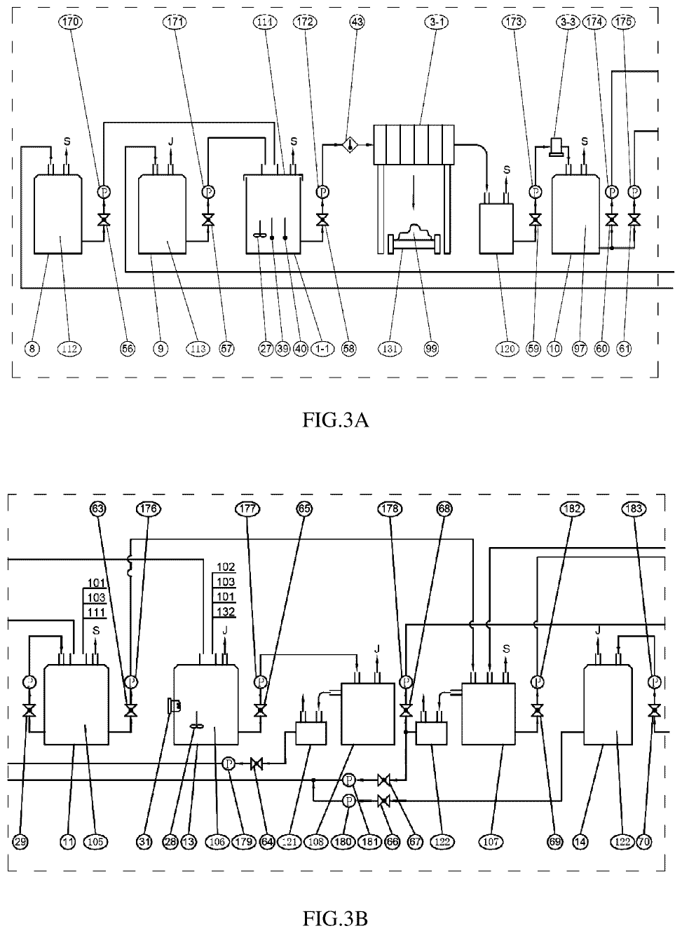

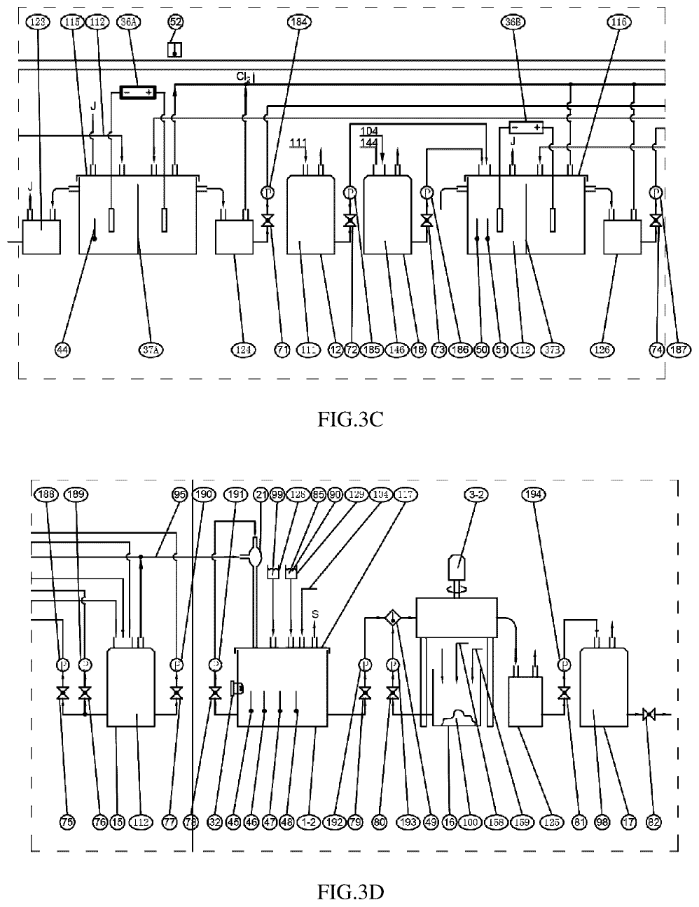

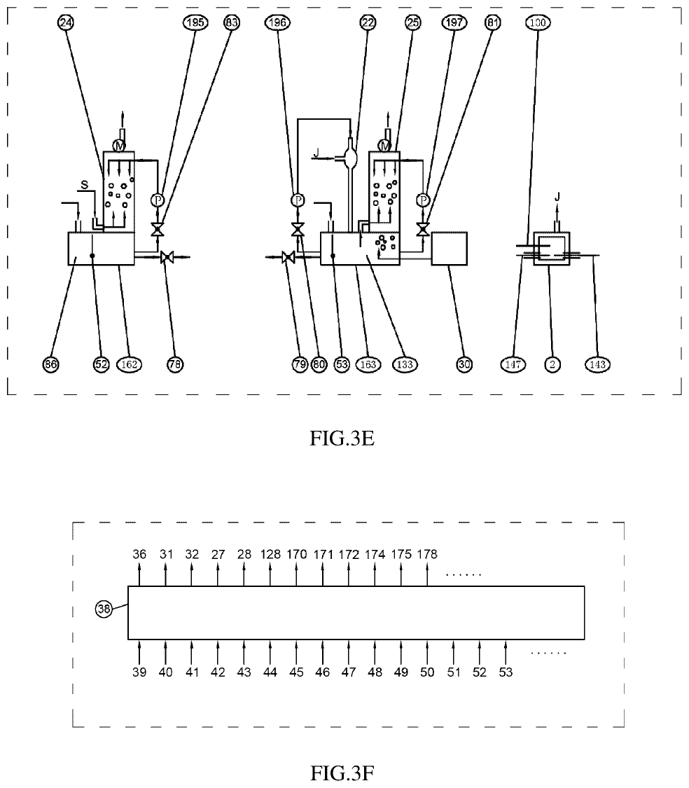

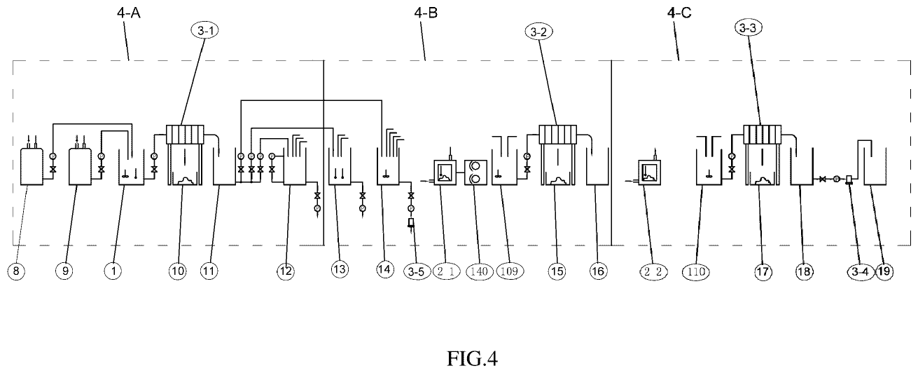

As shown in FIG. 3 and its partial enlarged view FIG. 3A, FIG. 3B, FIG. 3C, FIG. 3D, FIG. 3E and FIG. 3F, an apparatus for recycling of PCB copper chloride etching waste solution through precipitation treatment is provided in this example, including two reaction tanks, three solid-liquid separators, twelve temporary storage tanks, four solid feeders, fourteen detection device, a conveyor belt, two sets of electrolytic process chlorine generators (wherein the electrolytic cell separator 37 of the two electrolytic cells are anion exchange membranes), two tail gas treating devices, two etching production lines, 1 automatic detection and feeding controller, and 1 solid heating device.

A paddle stirring device 27, a sealing tank cover 114, a detection device 39 (specifically a pH meter), a detection device 40 (specifically a photoelectric colorimeter) are installed in the reaction tank 1-1, and a detection device 43 (specifically a flow meter) is installed on the connecting pipe between the reaction tank 1-1 and the solid-liquid separator 3. The reaction tank 1-2 is equipped with a sealing tank cover 117, a vacuum jetting gas-liquid mixing device 21, a heat exchange device 32, a detection device 45 (specifically a pH meter), a detection device 46 (specifically an ORP meter), a detection device 47 (specifically a thermometer), and a detection device 48 (specifically a liquid-level meter). The detection device 49 (specifically a flow meter) is installed on the connecting pipe between the reaction tank 1-2 and the solid-liquid separator 4.

The solid-liquid separator 3-1 adopts an ordinary filter press, and the solid-liquid separator 3-2 adopts a titanium rotary centrifuge with a scraper. The solid-liquid separator 3-3 is a common filter.

The multiple temporary storage tanks are used for temporary storage of different solutions as shown in FIG. 3. Wherein the temporary storage tank 11 is used to prepare the acidic etching replenishment solution, therefore the tank is provided with a liquid circulator 29; the temporary storage tank 13 is used to prepare the alkaline etching replenishment solution, therefore the tank is provided with a paddle stirring device 28 and a heat exchange device 31 used for heating. The temporary storage tank 12 is equipped with hydrochloric acid, and the temporary storage tank 18 is equipped with an acidic etching oxidant solution 146 (specifically a sodium chlorate oxidant solution). The temporary storage tank 15 is used for mixing the anolyte of the two electrolytic cells with the working etching solution on the etching line.

The solid feeder 128 is loaded with the filter residue C 99 transported from the conveyor belt 131, and the filter residue C 99 is added into the reaction tank 1-2 during operation.

A solid feeder 129 is provided with the reaction tank 1-2, and solid sodium hydroxide 85 and sodium carbonate 90 are loaded therein.

The main components of the acid copper chloride etching solution to be processed were copper chloride, ferric chloride, sodium chloride and hydrochloric acid, and the acidity of the etching solution was 1M. The alkaline pH value adjusting agent was an alkaline cupric chloride ammonia etching solution, the main components of which were cupric chloride ammonia, ammonia solution, ammonium chloride, and additives, and the pH value was pH 7.5.

The anolytes of the two electrolytic cell A and B (specifically chlorine gas generators that applies electrolysis) was a working acidic etching solution, and the catholyte of the two electrolytic cell A and B was an acid copper chloride etching waste solution. A detection device 44 (specifically a gravimeter) was installed in the cathode chamber of the electrolytic cell A, and its data was sent to the automatic detection and feeding controller 38 for processing, and the pump 178 was controlled to add acidic etching waste solution to the cathode chamber of the electrolytic cell A, so that the cathode continuously electrolytically deposit copper, and hence the anode of the electrolytic cell A electrolyzed chlorine gas and the cathode electrolytically deposit copper. And the detection device 50 and 51 (specifically an acidity meter and an ORP meter) were installed on the cathode chamber of the electrolytic cell B. The detection device 50 (specifically an acidity meter) controlled the hydrochloric acid in the temporary storage tank 12 to be added into the cathode chamber of the electrolytic cell B through the pump 185 to ensure that the catholyte was acidic; the detection device 51 (specifically an ORP meter) controlled the oxidant in the temporary storage tank 18 to be added into the cathode chamber of the electrolytic cell B through the pump 186 to ensure that the cathode neither electrolytically deposits copper nor generate hydrogen gas, so that the anode of the electrolytic cell B generates chlorine gas 95 and the cathode undergoes an electrochemical reaction with the oxidant. The anolyte of the two electrolytic cells were used to oxidize and regenerate the working etching solution on the acid etching line through an exchange tank 15 during the operation, it was unnecessary to add external oxidants during the acidic etching process. In addition, part of the chlorine gas 95 escaped from the anode chamber was led into the reaction tank 1-2 to participate in the chemical reaction. The reaction amount of introduced chlorine was controlled by the detection device 46 (specifically an ORP meter) in the reaction tank 1-2 to control the output power of the two or one of the electrolysis power supplies and to turn on and off to achieve the purpose of controlling the input amount of the ammonia nitrogen removal oxidant.

The solution of the reaction tank 1-2 was controlled by the detection device 45 (specifically a pH meter) to add a mixture of sodium hydroxide and sodium carbonate during the reaction to adjust the pH value of the reaction solution.

The tail gas treating device was divided into acidic tail gas treating device and ammonia alkaline tail gas treating device. The reaction solution in the acidic tail gas treatment device 162 was sodium hydroxide solution 86, and the reaction solution in the ammonia alkaline tail gas treating device 163 was sulfuric acid solution 133. The tail gas treating device could be installed with any one or a combination of the two types of gas-liquid mixing devices according to the process. As shown in FIG. 3, the acidic tail gas from each tank was led into the S inlet of the tail gas treating device 162 for treatment, and the ammonia-alkaline tail gas and the tail gas discharged from the solid heating device were led into the J inlet of the tail gas treating device 163 for treatment. The detection device 52 or 53 (specifically a pH meter) was respectively installed in the tail gas treating device, in order to alert when the tail gas treatment reaction solution needed to be replaced according to the process requirements during the operation. The tail gas treating device 163 is also provided with a gas inductor 30, which injects air into the tail gas treatment reaction solution to help the ammonia gas to accelerate the reaction with the sulfuric acid.

The etching production line includes an acidic etching production line 107 and an alkaline etching production line 108, so that the prepared acidic regenerated etching replenishment solution 105 can be reused in the acidic etching line for etching. The alkaline regenerated etching replenishment solution 106 can be added into the alkaline etching production line 108 for etching recycling.

The automatic detection and feeding controller 38 acquires data from multiple detection devices and performs automatic control on the production process of the whole set of apparatus.

Sodium sulfite solution 158 and sodium bisulfite solution 159 were prepared to wash the filter residue D, so that part of the sodium ferrate and sodium percuprate in the filter residue D 100 was reduced to copper oxide and iron oxide.

The solid heating device 2 was used for high-temperature heat treatment and oxidation processing of the copper oxide and iron oxide of the filter residue D after the reduction reaction, so as to recombine the structure of the iron oxide and copper oxide and evaporate water.

This example of the present disclosure is to recycle an acid copper chloride etching waste solution with an alkaline pH value adjusting agent which is an alkaline cupric chloride ammonia etching waste solution. The process was to turn on the two tail gas treatment devices to treat the tail gas, then pour the acid copper chloride etching waste solution 112 in the temporary storage tank 8 into the reaction tank 1-1 through the pump 170, turn on the paddle stirring device 27, and various data of the reaction solution was sent to the automatic detection and feeding controller 38 through the detection device 39 (specifically a pH meter) and the detection device 40 (specifically a thermometer) respectively. In the process, the pH meter controlled the pump 171 to add the alkaline copper chloride ammonia etching waste solution 113 in the temporary storage tank 9 to the reaction tank 1-1 for neutralization and precipitation reaction. The pH value of the reaction solution was controlled to be pH4.8, and after the neutralization reaction, a copper sludge was precipitated. The precipitated tail gas from the reaction tank 1-1 was diverted to the S inlet of the tail gas treating device 162 for treatment. According to the process, when the reaction of the solution in the reaction tank 1-1 was completed, the valve 58 was opened and the pump 172 was turned on to pump the solid-liquid mixture in the reaction tank 1-1 into the solid-liquid separator 3 (specifically a filter press) for SLS. During the process, the reading of the detection device 43 (specifically a pipeline flow meter) reflected the motion of the liquid flow in the pipe. When the reading of the detection device 43 returns to zero, it means that the material in the reaction tank 1-1 has been extracted, and the valve 58 is closed and the pump 172 is turned off. The filtrate A 97 flowing out from the solid-liquid separator 3 (specifically a filter press) was pumped into the temporary storage tank 10 through the overflow tank 120 and the filter 5. The plate-and-frames of the solid-liquid separator 3 (specifically a filter press) were opened and the filter residue C 99 was collected and dropped on the conveyor belt 131 and transported to the solid feeder 128. After completing the operation of the filter press, the plate-and-frames of the solid-liquid separator 3 (specifically a filter press) were closed again to prepare for the next operation. The filtrate A 97 in the temporary storage tank 10 was quantitatively distributed according to the process requirements, and was pumped into the temporary storage tank 11 through the pump 175 and into the temporary storage tank 13 through the pump 174. Ammonium chloride 101, hydrochloric acid 111, and additive 103 were added into the temporary storage tank 11 according to the process requirements, the liquid circulator 29 was turned on to prepare the acidic regenerated etching replenishment solution; ammonium chloride 101, ammonia solution 102, additive 103, liquid ammonia 132 were added into the temporary storage tank 13 as required, the paddle stirring device 28 and the heat exchange device 31 were turned on to prepare the alkaline regenerated etching replenishment solution. The heat exchange device 31 was used to adjust the temperature, so that the alkaline regenerated etching replenishment solution could reduce the ammonia gas escaped and could smoothly absorb heat and dissolve the ammonium chloride in the preparation process. The acidic regenerated etching replenishment solution 105 in the temporary storage tank 11 was added to the acidic etching production line 107 for etching recycling; the alkaline regenerated etching replenishment solution 106 prepared in the temporary storage tank 13 was added into the alkaline etching production line 108 for etching recycling.

The liquid level of addition of water 104 to the reaction tank 1-2 was controlled by the detection device 48 (specifically a liquid-level meter), and at the same time, the solid feeder 128 was turned on to quantitatively add the filter residue C 99 to the reaction tank 1-2. The pump 62 was turned on to start the vacuum jetting gas-liquid mixing device 21, the heat exchange device 32 was turned on to adjust and control the temperature of the reaction solution according to the process, and the tail gas was diverted to the S inlet suction port of the tail gas treating device 162 for treatment. The solution in the reaction tank 1-2 was sampled for ammonia nitrogen concentration analysis, and the NH₄ ion concentration was 28 g/L. The two chlorine gas generator that applies electrolysis were turned on, and the solid feeder 129 was controlled according to the detection device 45 (specifically a pH meter) to add a mixture of sodium hydroxide 85 and sodium carbonate 90 into the reaction tank 1-2. The anolyte of the two electrolytic cells was acid copper chloride etching waste solution. During the electrolysis process, the two electrolytic anode chambers, the overflow tanks 124 and 126, and the temporary storage tank 15 were used to let the anolyte flow through pumps and pipelines to liberate chlorine gas which was introduced into the reaction tank 1-2 to participate in the reaction. The other part of the chlorine gas reacted with the cuprous ions and ferrous ions in the working etching solution for oxidation. The copper ion concentration of the catholyte in the electrolytic cell A controlled the pump 178 according to the set value of the detection device 44 (specifically a gravimeter) to supplement the acid copper chloride etching waste solution 112 to the cathode chamber of the electrolytic cell A, and the cathode electrodeposit copper metal. After the catholyte in the electrolytic cell A was fully filled, the overflow tank 123 was used to pump the catholyte overflown from the electrolytic cell to the temporary storage tank 14 for temporary storage, or to the temporary storage tank 8. During the process, the detection device 45 (specifically a pH meter), the detection device 46 (specifically an ORP meter), the detection device 47 (specifically a thermometer), and the detection device 48 (specifically a liquid-level meter) transmitted the on-site data to the automatic detection and feeding controller 38 for processing and control. Among them, the pH value of the reaction solution in the reaction tank 1-2 was controlled to be pH14, the ORP value was controlled to be above 10 mV, and the temperature of the reaction solution was controlled at 55° C. When the solution in the reaction tank 1-2 reacted for 18 hours according to the process requirements, its analytical result of ammonia nitrogen concentration was 40 mg/L, so that the reaction was considered as completion and the electrolysis devices, the solid feeders 128 and 129, and the pump 191 were shut down. The valve 79 was opened, the pump 192 was turned on, and the liquid mixture in the reaction tank 1-2 was subjected to SLS by a rotary centrifuge 4, and the reading of the detection device 49 (specifically a flow meter) reflected the process. The filtrate B was pumped into the temporary storage tank 17 through the overflow tank 125 for temporary storage, and was left for further processing. Its components were mainly chloride salt and sodium ferrate solution, and the ammonia nitrogen impurity was 40 mg/L after analysis. And the filter residue D is scraped off in the temporary storage tank 16 by the scraper on the rotary centrifuge 4. When the reading of the detection device 49 (specifically a flow meter) returned to zero, it indicated that the solid-liquid mixture in the reaction tank 1-2 had been extracted, that is, the valve 79 was closed, the pump 192 and the rotary centrifuge 4 were stopped. The filter residue D 100 was a solid mixture containing sodium percuprate as the main component and chloride salt as the impurity. Sodium bisulfite 159 and sodium sulfite solution 158 were added to the temporary storage tank 16 to react with the solid mixture, so that sodium percuprate was reduced to copper oxide and a small amount of sodium ferrate was reduced to iron oxide. SLS was carried out by the solid-liquid separator 3-2 to obtain solid slag copper oxide and iron oxide.

The solid slag copper oxide and iron oxide after the reduction reaction was sent into the solid heating device 2 for high-temperature heating. The solid heating device is a combustion heating device that adopts combustible gas 147 and air 143 to generate combustion exothermic reaction. The heat treatment was 650° C. for 1 hour, and the copper oxide and iron oxide product obtained at high temperature were recycled.

A method for recycling of PCB copper chloride etching waste solution through precipitation treatment, including following steps:

(1) An acidic etching waste solution to be treated containing 1M hydrochloric acid was mixed and reacted with a PCB alkaline etching waste solution whose pH value was 7.5, until the pH value of the reaction solution reached pH 4.8 and there was precipitated copper sludge.

(2) The solid-liquid mixture obtained after the reaction in step (1) was subjected to SLS to obtain filtrate A and filter residue C; wherein the filtrate A was divided into two constant volume parts according to the process requirements to respectively prepare an acidic regenerated etching replenishment solution and an alkaline regenerated etching replenishment solution by composition adjustment, and the acidic regenerated etching replenishment solution was returned to the acid etching production line for etching recycling, and the alkaline regenerated etching replenishment solution was returned to the alkaline etching production line for etching recycling.

(3) The filter residue C was put into water and mixed with an inorganic base to form a suspension solution, and then the oxidation reaction for ammonia nitrogen removal was carried out with chlorine gas. During the process, the pH value of the reaction solution was controlled at pH 14, and its ORP value was controlled to be above 10 mV. The temperature of the reaction solution was 55° C., and the reaction time was as long as 18 hours. The mixture obtained after the reaction was subjected to SLS, obtaining filtrate B and filter residue D whose main component was sodium percuprate.

(4) The solid filter residue was subjected to the reduction reaction and was then put into a solid heating device for high-temperature oxidation treatment, so that the solid slag underwent a high-temperature reaction to become a new powder mixture of copper oxide and iron oxide for product reuse.

The feature of this example is to mix acid copper chloride etching waste solution and alkaline copper chloride etching waste solution for neutralization and precipitation reaction. The obtained filtrate A is divided into two parts according to the process and reused in etching production. The filter residue C adopts a combination of two impurity removal treatment methods including the approach (i) oxidation reaction for ammonia nitrogen removal and the approach (ii) heating oxidation treatment for ammonia nitrogen removal in step (3), so that the mixture of copper oxide and iron oxide can be easily separated during use, and the acid copper chloride etching waste solution and the alkaline copper chloride etching waste solution can be 100% recycled simultaneously in the production plant area.

### Example 4

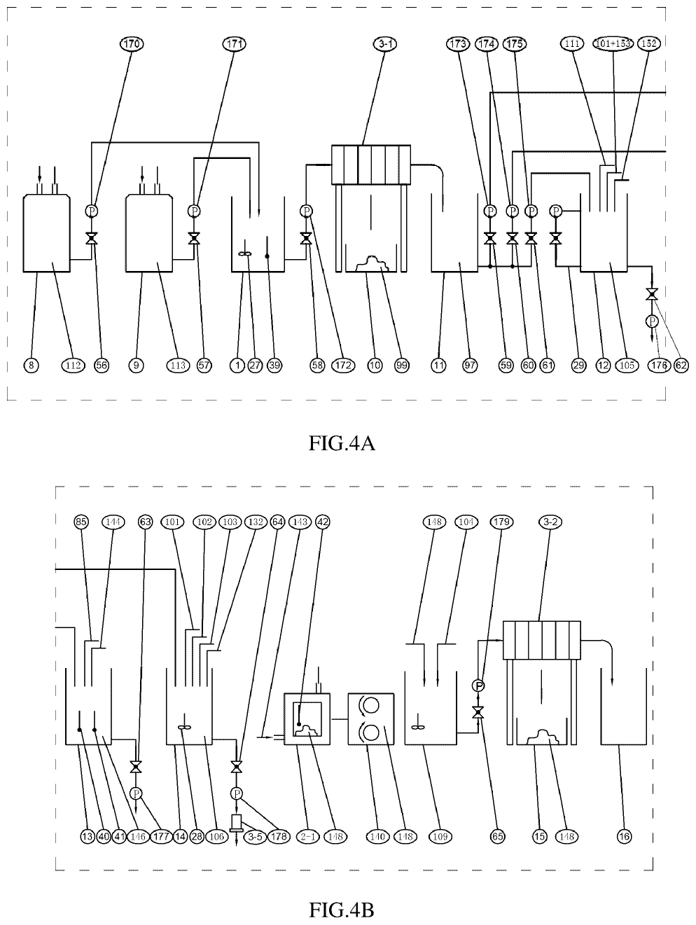

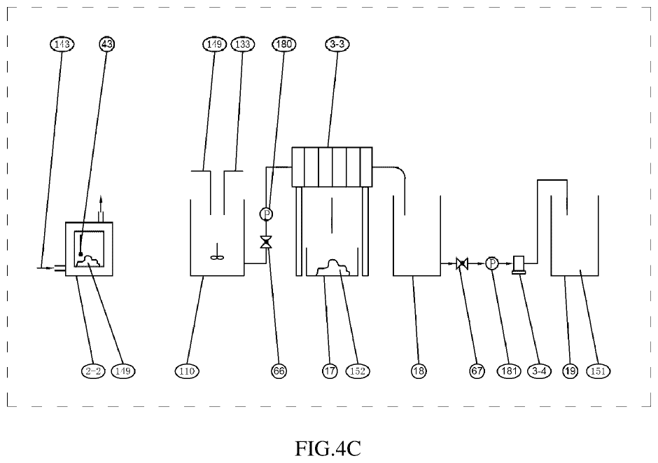

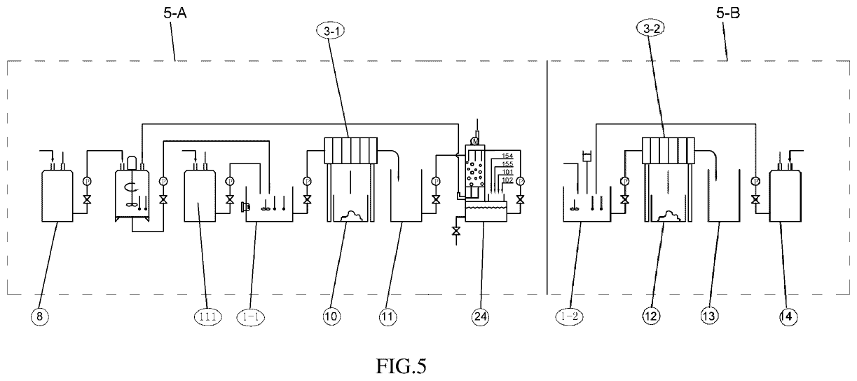

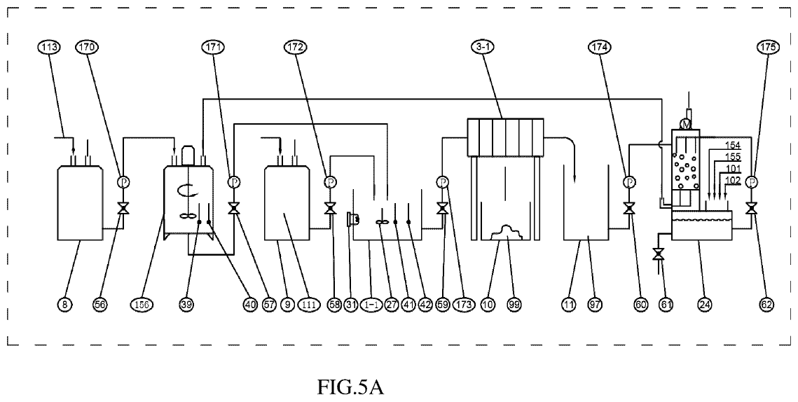

As shown in FIG. 4 and its partial enlarged view FIG. 4A, FIG. 4B and FIG. 4C, an apparatus for recycling of PCB copper chloride etching waste solution through precipitation treatment is provided in this example, including a reaction tank 1, five solid-liquid separators 3-1 to 3-5, twelve temporary storage tanks 8-19, five detection device, two solid heating devices 2-1 and 2-2, a pulverizer 140, a washing tank with a stirring device for copper sludge 110, pumps and valves.

The paddle stirring device 27, the detection device 39 (specifically a pH meter) are installed in the reaction tank 1, which is connected to the solid-liquid separator 3-1 through a pipeline provided with a valve 58 and a pump 172;

The solid-liquid separators 3-1 to 3-3 all use ordinary filter presses, and the solid-liquid separator 3-4 is an ordinary wound precision cartridge filter.

The temporary storage tank 8 is used to store acidic etching waste solution, the temporary storage tank 9 is used to store alkaline etching waste solution, the temporary storage tank 10 is used to store the filter residue C 99 from the solid-liquid separator 3-1, the temporary storage tank 11 is used to store the filtrate A 97, the temporary storage tank 12 is used to prepare the acidic etching replenishment solution, the temporary storage tank 13 is used to prepare the acidic etching oxidant solution, and the temporary storage tank 14 is used to prepare the alkaline regenerated etching replenishment solution. The temporary storage tank 15 is used for storing the copper slag 148 (specifically a mixture of copper oxide powder and iron oxide powder) obtained after mechanical pulverization, washing and SLS. The temporary storage tank 16 is used for temporarily storing the waste solution of washing the copper slag 148 (specifically a mixture of copper oxide powder and iron oxide powder).

The pulverizer 140 is used to mechanically pulverize the copper slag 148 processed by the solid heating device 2-1.

The solid heating device 2-1 is used for the heating oxidation treatment for ammonia nitrogen removal on the filter residue C 99, which is a precipitated copper sludge.

The solid heating device 2-2 is used for performing high-temperature oxidation treatment on the copper slag 148 that has been heated, crushed and washed.

The washing tank with a stirring device for copper sludge 110 is used to dissolve copper oxide with sulfuric acid to separate copper oxide from the mixture 149 of iron oxide and manganese dioxide.

The alkaline cupric chloride ammonia etching waste solution to be treated was an aqueous solution at pH 8.8 containing ammonia solution, ammonium chloride, cupric chloride ammonia and additives. The acidic pH value adjusting agent was an acid copper chloride etching waste solution with an acidity of 3.5M, whose main component was an acidic solution containing hydrochloric acid, copper chloride, ferric chloride and ammonium chloride.

The process of this example was to turn on the pump 171 to pump the alkaline copper chloride ammonia etching waste solution 113 in the temporary storage tank 9 to the reaction tank 1 until a certain volume is reached, and turn on the paddle stirring device 27. The pump 170 was controlled according to the detection device 39 (specifically a pH meter) to add the acidic pH value adjusting agent in the temporary storage tank 8 to the reaction tank 1, in order to react with the alkaline copper chloride ammonia etching waste solution 113. During the process, when the pH meter reached the set value of pH 3.2, the pump 53 was turned off, and precipitates formed in the reaction solution. The valve 58 was opened and the pump 172 was turned on to pump the solid-liquid mixture in the reaction tank 1 to the solid-liquid separator 3 (specifically a filter press) for SLS. The obtained filtrate A was directed to the temporary storage tank 11, and the filter residue C was left in the solid-liquid separator 3. When the solid-liquid mixture in the reaction tank 1 was completely pumped out, the valve 58 was closed and the pump 172 was turned off. The filter residue C was taken out from the solid-liquid separator 3 (specifically a filter press) and was put into the temporary storage tank 10, and then the plate-and-frames of the filter press were closed to prepare for the next operation. The valves 60 and 61 were opened and the pumps 174 and 175 were turned on to pump a part of the filtrate A 97 in the temporary storage tank 11 to the temporary storage tanks 12 and 13 respectively to prepare an acidic regenerated etching replenishment solution and an acidic etching oxidant solution. At the same time, the remaining part of the filtrate A was pumped into the temporary storage tank 14 by the pump 173 to prepare an alkaline regenerated etching replenishment solution. The insoluble impurities in the prepared alkaline regenerated etching replenishment solution were filtered out by passing the alkaline regenerated etching replenishment solution 106 through the filter 7.

The solid filter residue C 99 was taken out from the temporary storage tank 10 and was put into the solid heating device 2-1. The heating device was specifically an electric heating device. The solid heating device 2-1 was turned on to directly heat the filter residue C at 120° C. for 3 hours. According to the process requirements, when the heating oxidation treatment for ammonia removal was completed, the electric heating device 134 was turned off, and the copper slag 148 product was taken out and transferred to the pulverizer 140 for crushing. And then the copper slag 148 was put into the washing tank 109 and washed with water to remove soluble salt impurities in the copper slag 148. After that, the pump 179 was turned on to pump the solid-liquid mixture in the washing tank 109 to the solid-liquid separator 3-2 for SLS, and the cleaning waste solution was drained into the temporary storage tank 16 for processing. The filter residue 148 was obtained from the solid-liquid separator 3-2 and placed in the temporary storage tank 15 for temporary storage.

The copper slag 148 in the tank 15 was put into the electrical solid heating device 2-2 for a high-temperature oxidation treatment at 850° C. The copper slag was stirred and flipped during the oxidation reaction for two hours, and was taken out to cool down.

The copper slag 149 and the sulfuric acid solution 133 were added into the washing tank 110 to prepare the copper sulfate solution. When the reaction is completed, the pump 180 was turned on to separate the solid-liquid mixture in the washing tank 110 through the solid-liquid separator 3-3. The obtained crude product of acidic copper sulfate solution was stored in the temporary storage tank 18, and then a relatively pure acidic copper sulfate solution 151 was obtained by fine filtration through a solid-liquid separator 3-4 (specifically a precision filter). Iron oxide and manganese dioxide are insoluble in sulfuric acid and were intercepted by the solid-liquid separator 3-3 and 3-4 respectively, and then the solid-liquid separator 3-3 was opened to collect the iron oxide 152 and store it in the temporary storage tank 17. After the manganese dioxide in the iron oxide 152 was separated, the iron oxide was reused in preparing an acidic regenerated etching replenishment solution.

A method for recycling of PCB copper chloride etching waste solution through precipitation treatment, including following steps:
(1) A PCB alkaline etching waste solution to be treated with pH 8.8 was mixed with an acidic pH value adjusting agent for reaction until the pH of the reaction solution reached pH 3.2 and copper sludge precipitated;
(2) The mixture obtained after the reaction in step (1) was subjected to SLS to obtain filtrate A and filter residue C;
(3) The first electric heating oxidation treatment for ammonia removal at 120° C. on the filter residue C was conducted, and copper oxide and iron oxide were formed in the reaction process.
(4) The filtrate A was used to prepare an acidic regenerated etching replenishment solution and an acidic etching oxidant solution for reuse on the acid etching production line, and to prepare an alkaline regenerated etching replenishment solution for reuse on the alkaline etching production line.
(5) After the first electric heating oxidation treatment, the filter residue C was mechanically pulverized and washed with water for salt removal, and the treated copper slag was again subjected to high-temperature electric heating at 850° C. for ammonia nitrogen removal and/or chloride salt removal and/or removal of metal impurities other than copper, to obtain a product containing copper oxide powder, iron oxide powder and trace manganese dioxide impurity.
(6) React the copper oxide powder and iron oxide powder with sulfuric acid solution, and obtain acidic copper sulfate solution and iron oxide powder after fine filtration. The iron oxide powder was reused in the preparation of the acidic regenerated etching replenishment solution after the manganese dioxide impurities were separated.

The characteristic of this example is an acid copper chloride etching waste solution and an alkaline copper chloride etching waste solution are mixed and neutralized in the factory area of the PCB production enterprise. The approach (ii) in step (3) is adopted in the process. This method can reduce the process and equipment that require ammonia nitrogen removal oxidant, the operation is safe and simple, significantly saving equipment investment funds. There is no new pollution sources occur, and it is easily realize the mixed treatment of acid copper chloride etching waste solution and alkaline copper chloride etching waste solution, and at the same time achieve the ideal effect of 100% recycling.

### Example 5

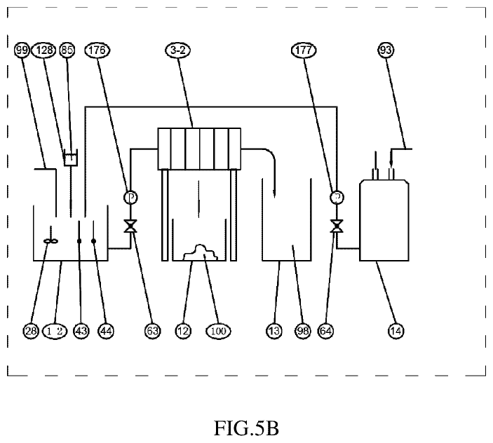

As shown in FIG. 5 and its partial enlarged view FIG. 5A and FIG. 5B, an apparatus for recycling of PCB copper chloride etching waste solution through precipitation treatment is provided in this example, including reaction tanks 1-1 and 1-2, solid-liquid separators 3-1 and 3-2, temporary storage tanks 8-14, a spraying tower gas-liquid mixing device 24, a heat exchange device 31, and a chemical reactor 156.

The reaction tank 1-1 is provided with a paddle stirring device 27, a heat exchange device 31, and detection devices 41 and 42 (specifically a pH meter and an ORP meter). The reaction tank 1-1 is connected to the solid-liquid separator 3-1 through a pipeline provided with a valve 71 and a pump 56; a paddle stirring device 28, a detection device 43 (specifically a pH meter) and a detection device 44 (specifically an ORP meter) are provided in the reaction tank 1-2. The reaction tank 1-2 is connected with the solid-liquid separator 3-2 through a pipeline provided with a valve 75 and a pump 59.

The solid-liquid separator 3-1 and 3-2 are both common filter press;

The chemical reactor 156 is an electrothermal reactor, wherein a paddle stirring device is provided, and detection devices 39 and 40 (specifically a pH meter and a thermometer) are used for process control of heating and removing ammonia from the alkaline etching waste solution.

The temporary storage tank 8 is used to store an alkaline copper chloride ammonia etching waste solution 113, the temporary storage tank 9 is used to store a pH value adjusting agent which was a mixed solution of hydrochloric acid 111 and formic acid 142, the temporary storage tank 10 is used to store the filter residue C 99 obtained from the solid-liquid separator 3 (specifically a filter press), the temporary storage tank 11 is used to store the filtrate A 97 from the solid-liquid separator 3-1, the temporary storage tank 12 is used to store the filter residue D 100 obtained from the separation of the solid-liquid separator 3-2, and the temporary storage tank 13 is used to store the filtrate B 98 from the solid-liquid separator 3-2, the temporary storage tank 14 is filled with sodium hypochlorite solution 93.

A solid feeder 128 is also provided above the reaction tank 1-2, wherein sodium hydroxide 85 is stowed.

The alkaline copper chloride ammonia etching waste solution 113 to be treated had a pH value of 7.3, and it was an aqueous solution whose main components are ammonium chloride, ammonium carbonate, ammonium bicarbonate, ammonia solution, and copper chloride ammonia. Its copper ion concentration was 90 g/L. The acidic pH value adjusting agent was hydrochloric acid.

In the recovery and regeneration process, the pump 170 was first turned on to pump the alkaline copper chloride ammonia etching waste solution 113 in the temporary storage tank 8 into the chemical reactor 156. The paddle stirring device and heater of the reactor were turned on to heat the alkaline copper chloride ammonia etching waste solution 113 for ammonia removal. The ammonia removal process was controlled by the detection device 39 (specifically a pH meter) and the detection device 40 (specifically a thermometer). During the process, the working temperature in the reactor was controlled at 95° C., the pH value of the heated reaction solution in the reactor was controlled at pH 6.8, and the ammonia-containing tail gas escaped from the reactor was diverted to the spraying tower gas-liquid mixing device 24 for absorption so that it was utilized in the preparation of the regenerated etching replenishment solution. When the values of the detection device 39 and 40 reached the process set value, the heater of the chemical reactor was turned off and the temperature of the solution in the reactor was lowered. After the solution in the reactor cooled down, the concentrated slurry was pumped to the reaction tank 1-1 by the pump 171 for the following chemical reaction of neutralization and precipitation of copper salt. The addition of the hydrochloric acid solution in the tank 9 to the reaction solution in the reaction tank 1-1 through the pump 172 was controlled by the detection device 41 (specifically a pH meter) during the process. The process set value of the pH meter in step (1) was pH5.0. When the acidic pH value adjusting agent which is hydrochloric acid was added through the pump 172, the pH value of the reaction solution in the reaction tank 1-1 reached pH 5.0 and a precipitate occurred. During the neutralization exothermic reaction, the reaction solution was cooled by the heat exchange device 31. When the precipitation reaction was completed, the valve 59 was opened and the pump 173 was turned on to pump the solid-liquid mixture in the reaction tank 1-1 to the solid-liquid separator 3 (specifically a filter press) for SLS, and the filtrate A was led to the temporary storage tank 11. The valve 59 was closed and the pump 173 was turned off after the mixture in reaction tank 1-1 was completely pumped out. The filter residue C was collected by opening the plate-and-frames of the solid-liquid separator 3 (specifically a filter press) and was temporarily placed in the temporary storage tank 10. The plate-and-frames of the solid-liquid separator 3 (specifically a filter press) were closed again after collecting the solid filter residue C, and waited for the next operation.

The filtrate A 97 was pumped into the spraying tower gas-liquid mixing device 24 by the pump 174 to prepare an alkaline regenerated etching replenishment solution. During the process, by absorbing ammonia-containing tail gas, adding ammonium carbonate salt, ammonium chloride, and ammonia solution raw materials, the alkaline regenerated etching replenishment solution was prepared, and it was analyzed by laboratory technicians before using in an alkaline etching production line to ensure the preparation standard of the regenerated etching replenishment solution was met.

The filter residue C solid in the temporary storage tank 10 was put into the reaction tank 1-2, the valve 64 was opened and the pump 177 was turned on to introduce the sodium hypochlorite salt solution 93 into the reaction tank 1-2. The concentration of ammonia nitrogen was 11 g/L in the analytical test. The paddle stirring device 28 was turned on, the detection device 43 (specifically a pH meter) and the detection device 44 (specifically an ORP meter) worked simultaneously, and the detection device 44 controlled the pump 177 to add the ammonia nitrogen removal oxidant solution in the temporary storage tank 14 into the reaction tank 1-2. The process set value of the ORP meter was 420 mV. While adding the ammonia nitrogen removal oxidant solution, the solid feeder 128 was turned on and sodium hydroxide 85 was put in the reaction tank 1-2. The input amount of the sodium hydroxide 85 was controlled according to the process set value pH8.8 in step (3) by the detection device 43 (specifically a pH meter). The temperature of the reaction solution was room temperature. The ammonia nitrogen concentration was 140 mg/L after reacting 34 hours, and the ammonia nitrogen removal oxidation reaction was considered to be completed. The valve 63 was opened and the pump 176 was turned on to transfer the solid-liquid mixture in the reaction tank 1-2 to the solid-liquid separator 4 (specifically a filter press) for SLS, the filtrate B 98 is diverted into the temporary storage tank 13, and the filter residue D 100 is retained in the solid-liquid separator 4 (specifically a filter press). The solid-liquid separator 4 (specifically a filter press) was then opened to collect the filter residue D intercepted in the device, and the collected filter residue was temporarily stored in the temporary storage tank 12. The filter residue D obtained after the oxidation treatment for ammonia nitrogen removal was mainly composed of copper hydroxide.

The filter residue D sodium hydroxide was recycled. The ammonia nitrogen impurity in the filtrate B in the temporary storage tank 13 was still remained at 140 mg/L.

A method for recycling of PCB copper chloride etching waste solution through precipitation treatment, including following steps:
(1) A PCB alkaline copper chloride etching waste solution with a pH value of 7.3 was treated under high-temperature for ammonia removal in a chemical reactor, and was then mixed with an acidic substance for reaction, until the pH value of the reaction solution reached pH 5.0 and there was copper sludge is precipitated;
(2) The solid-liquid mixture obtained after the reaction in step (1) was subjected to SLS to obtain a filtrate A and a filter residue C;
(3) The filter residue C was mixed with sodium hypochlorite to carry out the ammonia nitrogen removal oxidation reaction. During this period, sodium hydroxide 85 was added to the reaction tank through the solid feeder to maintain the pH value parameter of the reaction solution at pH=8.8, and the oxidant was added until the ORP value of the reaction solution reached and maintained above 520 mV for 34 hours, and then the reaction was completed. After the reaction, the solid-liquid mixture in the reaction tank 1-2 was subjected to SLS to obtain a filtrate B and a filter residue D whose main component was copper hydroxide.
(4) The filtrate A was used to absorb the ammonia-containing tail gas discharged from the chemical reactor, and ammonium carbonate, ammonium chloride, and ammonia solution were added to prepare an alkaline regenerated etching replenishment solution which was reused in an alkaline etching production line.

The characteristic of this example is that before the neutralization and precipitation reaction, the alkaline etching waste solution is heated to remove ammonia in order to reduce the pH value of the original alkaline copper chloride etching waste solution, so that the input amount of the acidic pH value adjusting agent is reduced, and the volume of the filtrate A 97 obtained after the neutralization and precipitation reaction will not be greater than the volume of the waste solution to be treated.

This example of the present disclosure is to illustrate the single recycling process of an alkaline copper chloride etching waste solution, wherein hydrochloric acid was used as an acidic pH value adjusting agent for neutralization and precipitation reaction. After the heating treatment for ammonia removal, an acidic pH value adjusting agent was added to generate ammonium chloride in the reaction solution to reduce the pH value of the solution and allow copper salt precipitate in the solution. Subsequently, the precipitated copper sludge was subjected to the ammonia nitrogen removal oxidation treatment by adopting the approach (i) in step (3) to recover copper hydroxide. During the process, the alkaline etching waste solution was heated to remove ammonia by the reactor, so that there was no excessive filtrate A 97 which cannot be reused after waste solution treatment, and there was no new sources of pollution generated in the entire recovery system.

### Example 6

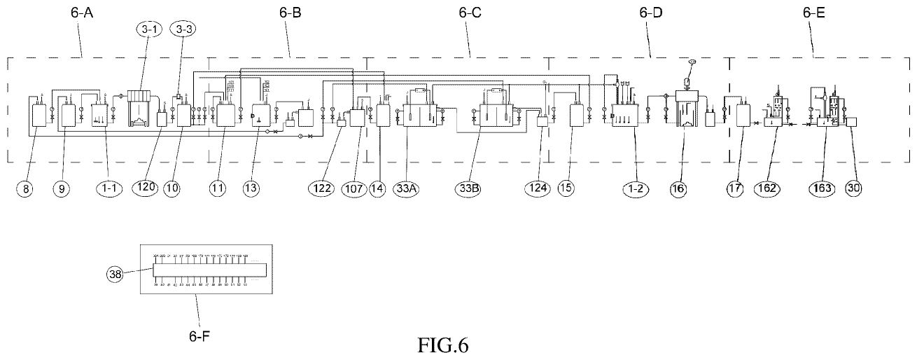

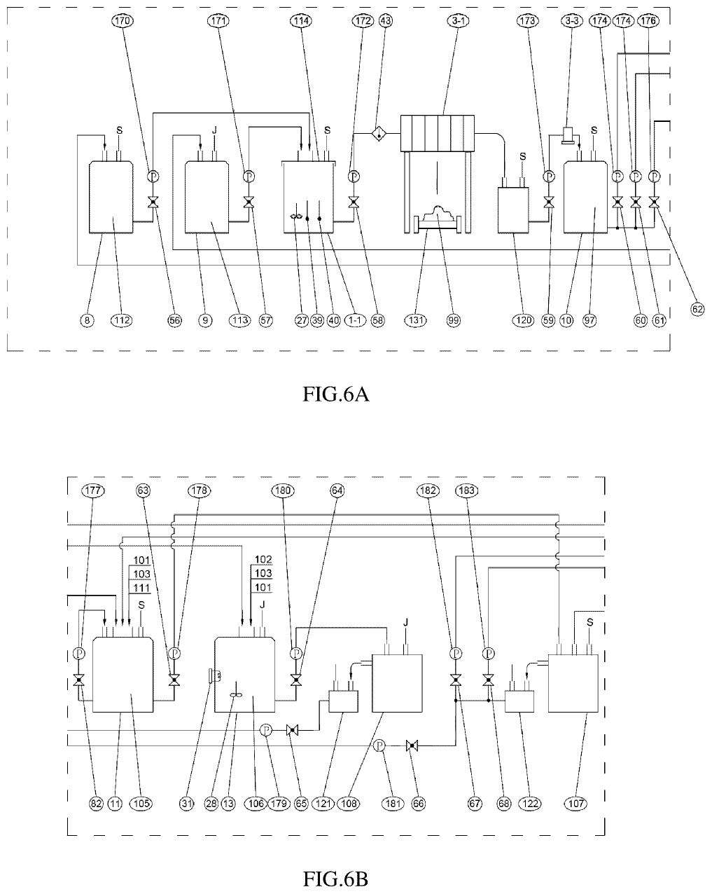

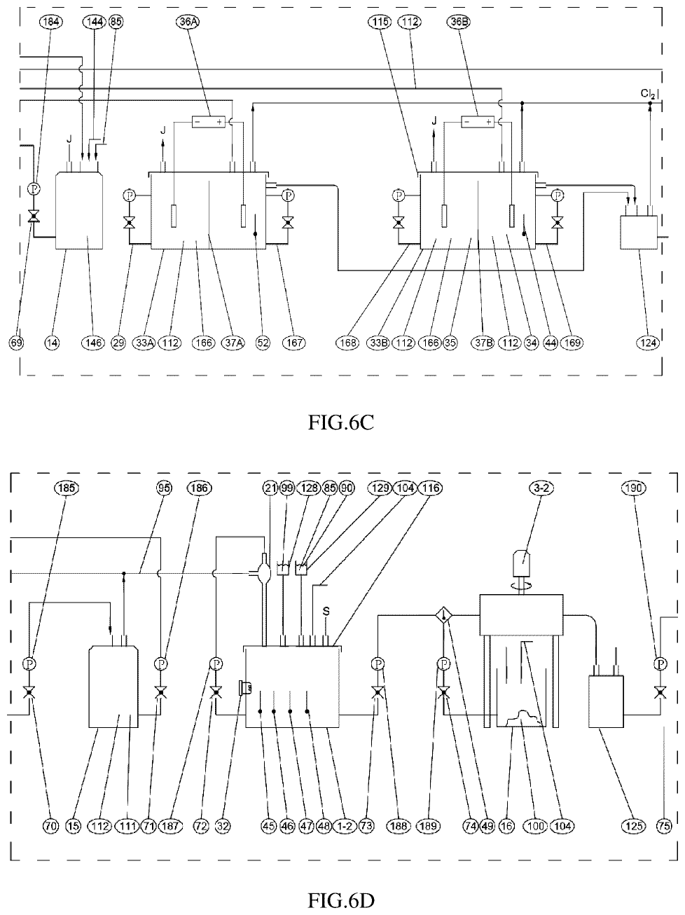

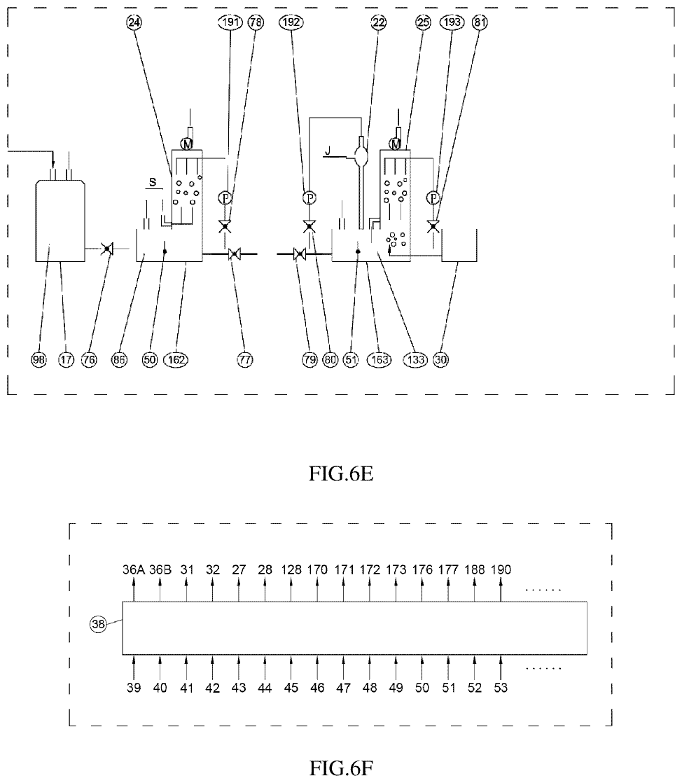

As shown in FIG. 6 and its partial enlarged view FIG. 6A, FIG. 6B, FIG. 6C, FIG. 6D, FIG. 6E and FIG. 6F, an apparatus for recycling of PCB copper chloride etching waste solution through precipitation treatment is provided in this example, including two reaction tanks, three solid-liquid separators, ten temporary storage tanks, two solid feeders, fourteen detection device, a conveyor belt, and two sets of chlorine gas generator that applies electrolysis 33A and 33B (wherein the electrolytic cell separator 37A of the electrolytic cell 33A is a cation exchange membrane, and the electrolytic cell separator 37B of the electrolytic cell 33B is a filter cloth), two exhaust gases Processing tank, two etching production lines, and an automatic detection and feeding controller.

A paddle stirring device 27, a sealing tank cover 114, a detection device 39 (specifically a pH meter), and a detection device 40 (specifically a photoelectric colorimeter) are provided in the reaction tank 1-1, and a detection device 43 (specifically a flow meter) is provided on the pipeline connecting the reaction tank 1-1 and the solid-liquid separator 3-1. A sealing tank cover 116, a vacuum jetting gas-liquid mixing device 21, a heat exchange device 32, a detection device 45 (specifically a pH meter), a detection device 46 (specifically an ORP meter), a detection device 47 (specifically a thermometer), and a detection device 48 (specifically a liquid-level meter) are provided in the reaction tank 1-2. A detection device 49 (specifically a flow meter) is provided on the pipeline connecting the reaction tank 1-2 and the solid-liquid separator 3-2.

The solid-liquid separator 3-1 is an ordinary filter press, and the solid-liquid separator 3-2 is a titanium rotary centrifuge with a scraper. The solid-liquid separator 3-3 is a common filter.

The multiple temporary storage tanks shown in FIG. 6 are used for temporary storage of different solutions. Wherein the temporary storage tank 11 is used to prepare an acidic etching replenishment solution, so that a liquid circulator 29 is provided with the tank; the temporary storage tank 14 is used to prepare an acidic etching oxidant solution; the temporary storage tank 13 is used to prepare an alkaline etching replenishment solution, so that a paddle stirring device 28 and a heat exchange device 31 used for heating are provided with the tank 13.

The solid feeder 128 was loaded with the filter residue C 99 transported from the conveyor belt 131, which was added into the reaction tank 1-2 during the process.

The solid feeder 129 is provided above the reaction tank 1-2, and solid sodium hydroxide 85 and sodium carbonate 90 were loaded therein.

The main components of the acid copper chloride etching solution to be processed were copper chloride, ammonium chloride and hydrochloric acid, and the acidity was 1.8M. The alkaline pH value adjusting agent was an alkaline copper chloride ammonium etching solution whose main components were copper ammonium chloride, ammonia solution, ammonium chloride and additives, and the pH value was pH8.3.

In step (3) of the method, the approach (i) was adopted for ammonia nitrogen removal oxidation treatment.

The two sets of electrolytic process chlorine generators both adopted an acid copper chloride etching waste solution as the anolyte and the catholyte of their electrolytic cell. The electrolytic cell separator of the electrolytic cell 33A was a cation exchange membrane, and the electrolytic cell separator of the electrolytic cell 33B was a filter cloth. During the electrolysis operation, chlorine gas 95 was produced on the two anodes and copper formed on the cathodes through the electrochemical reaction. Wherein, the acidic etching waste solution was continuously added to the anode chamber of the two electrolytic cells during the electrolysis process, and the pumps 182 and 183 provided in the anode chambers were respectively controlled by the detection device 44 and 52 (specifically gravimeters) to perform additional feeding. During the electrolysis process, the chlorine gas 95 escaped from the two anode chambers and the overflow tank 124 was led by the vacuum jetting gas-liquid mixing device 21 into the reaction tank 1-2 to participate in the chemical reaction. The amount of chlorine reaction introduced was controlled by the detection device 46 (specifically an ORP meter) in the reaction tank 1-2 by controlling the output power and to turn on and off of the two electrolysis power supplies 36A and 36B, so that the amount of oxidant added to the ammonia nitrogen removal reaction was controlled.

Addition a mixture of sodium hydroxide and sodium carbonate to the solution in the reaction tank 1-2 during the reaction was controlled by the detection device 45 (specifically a pH meter) to adjust the pH value of the reaction solution.

The tail gas treating device was divided into acidic tail gas treating device and alkaline ammonia tail gas treating device. The absorption solution of the acidic tail gas treating device was sodium hydroxide solution 86, and the absorption solution of the alkaline ammonia tail gas treating device was sulfuric acid solution 133. The tail gas treating device can be installed with any one or a combination of two gas-liquid mixing devices according to the process requirement. As shown in FIG. 6, the acidic tail gas from each tank is introduced into the S inlet of the tail gas treating device 162 for treatment, and the ammonia-alkaline tail gas from each tank is introduced into the J inlet of the tail gas treating device 163 for treatment. The detection device 50 and 51 (specifically pH meters) are respectively installed in the tail gas treating devices, in order to alert when the tail gas treatment reaction solution needed to be replaced according to the process requirements during the operation. The tail gas treating device 163 is also provided with a gas inductor 30, which injects air into the tail gas treatment reaction solution to help the ammonia gas to accelerate the reaction with the sulfuric acid.

The etching production line includes an acidic etching production line 107 and an alkaline etching production line 108, so that the prepared acidic regenerated etching replenishment solution 105 and the acidic etching oxidant solution 146 were returned to the acidic etching line through the pump 178 for PCB copper etching. The alkaline regenerated etching replenishment solution 106 was added into the alkaline etching production line 108 through the pump 180 for PCB copper etching and recycling.

The automatic detection and feeding controller 38 automatically controls the production process of the whole apparatus according to the on-site data from the detection devices.

This example is to process an acid copper chloride etching waste solution, and the alkaline pH value adjusting agent was the alkaline cupric chloride ammonia etching waste solution. The process was to turn on two tail gas treating devices, pump the acid copper chloride etching waste solution 112 in the temporary storage tank 8 into the reaction tank 1-1 through the pump 170, turn on the paddle stirring device 27, and transmit various on-site data of the reaction solution through the detection device 39 (specifically a pH meter) and the detection device 40 (specifically a thermometer) to the automatic detection and feeding controller 38 for processing. During the process, the detection device 39 (specifically a pH meter) controled the pump 171 to add the alkaline copper chloride ammonia etching waste solution 113 in the temporary storage tank 9 into the reaction tank 1-1 for neutralization and precipitation reaction. The pH value of the reaction solution was controlled to be pH 5.2, and there was copper sludge precipitated. The tail gas from the reaction tank 1-1 was diverted to the S inlet of the tail gas treating device 162 for treatment. According to the process, when the reaction of the solution in the reaction tank 1-1 was completed, the valve 58 was opened and the pump 172 was turned on to pump the solid-liquid mixture in the reaction tank 1-1 into the solid-liquid separator 3 (specifically a filter press) for SLS. The reading of the detection device 43 (specifically a pipeline flow meter) reflected whether there is liquid flow in the pipeline. When the reading of the detection device 43 returns to zero, it means that the material in the reaction tank 1-1 has been completely extracted, and the valve 58 is closed and the pump 172 is turned off. The filtrate A 97 flowing out from the solid-liquid separator 3 (specifically a filter press) was pumped into the temporary storage tank 10 through the overflow tank 120 and the filtering device 5. The plate-and-frames of the solid-liquid separator 3 (specifically a filter press) was opened to collect and drop the filter residue C 99 on the conveyor belt 131 and transport it to the solid feeder 128. After that, the plate-and-frames of the solid-liquid separator 3 (specifically a filter press) were closed again to prepare for the next operation. The filtrate A 97 in the temporary storage tank 10 was quantitatively distributed according to the process requirements, and was pumped into the temporary storage tank 11, the temporary storage tank 13 and the temporary storage tank 14 by the pumps 176, 175, and 174 respectively. Ammonium chloride 101, hydrochloric acid 111, and additive 103 were added into the temporary storage tank 11 according to the process requirements, the liquid circulator 29 was turned on to prepare the acidic regenerated etching replenishment solution; ammonium chloride 101, ammonia solution 102, additive 103 were added into the temporary storage tank 13 as required, the paddle stirring device 28 and the heat exchange device 32 were turned on to prepare the alkaline regenerated etching replenishment solution. The heat exchange device 31 was used to adjust the temperature, so that the alkaline regenerated etching replenishment solution could reduce the ammonia gas escape and can smoothly absorb heat to dissolve ammonium chloride in the preparation process. Sodium hydroxide 85 was added to the temporary storage tank 14 for pH adjustment to make the solution neutral, and then sodium chlorate 144 was added to prepare an acidic etching oxidant solution 146.

The liquid level of addition of water 104 to the reaction tank 1-2 was controlled by the detection device 48 (specifically a liquid-level meter), and at the same time, the solid feeder 128 was turned on to quantitatively add the filter residue C 99 to the reaction tank 1-2. The pump 62 was turned on to start the vacuum jetting gas-liquid mixing device 21, the heat exchange device 32 was turned on to adjust and control the temperature of the reaction solution according to the process, and the tail gas was diverted to the S inlet suction port of the tail gas treating device 162 for treatment. The solution in the reaction tank 1-2 was sampled for ammonia nitrogen concentration analysis, and result of the NH⁴⁺ ion concentration was 126 g/L. The two chlorine gas generator that applies electrolysis were turned on, and the solid feeder 129 was controlled according to the detection device 45 (specifically a pH meter) to add a mixture of sodium hydroxide 85 and sodium carbonate 90 into the reaction tank 1-2. The anolyte of the two chlorine gas generator that applies electrolysis was acid copper chloride etching waste solution, and the chlorine gas produced on the anode during operation was used in the oxidation reaction for ammonia nitrogen removal of the materials in the reaction tank 1-2, while copper was electrolytically precipitated on the cathodes. The copper ion concentration of the anolyte of the two electrolytic cells was controlled by controlling the pumps 182 and 183 according to the set values of the detection devices 44 and 52 (specifically gravimeters) to add the acid copper chloride etching waste solution 112 respectively into the anode chambers of the two electrolytic cells. The catholyte was a mixed solution of acid copper chloride etching waste solution 112 and an electroplating copper brightening agent 166. Because the electrolytic cell separator of the electrolytic cell 33A was a cation exchange membrane and the electrolytic cell separator of the electrolytic cell 33B was a filter cloth, the copper ions in the two anode chambers migrated to the cathode chambers under the effect of an electric field and metallic copper was electrolytically deposit on the cathodes. During the process, the detection device 45 (specifically a pH meter), the detection device 46 (specifically an ORP meter), the detection device 47 (specifically a thermometer), and the detection device 48 (specifically a liquid-level meter) provided with the reaction tank 1-2 transmitted on-site data to the automatic detection and feeding controller 38 for processing and control. The pH value of the reaction solution in reaction tank 1-2 was controlled at pH 11, the ORP value was controlled to be above 1 mV, the temperature of the reaction solution was 5° C. and the reaction solution was reacted for 52 hours. The ammonia nitrogen concentration of the reaction solution was analyzed, and the result was 80 mg/L. The reaction was considered to be completed, and the electrolysis devices, the solid feeders 128 and 129, the pumps 182, 183, 187 were turned off, the valve 73 was opened, the pump 188 and the rotary centrifuge 4 were turned on to separate the solid-liquid mixture in the reaction tank 1-2, and the detection device 49 (specifically a flow meter) reflected the reading during the process. The filtrate B was pumped into the temporary storage tank 17 through an overflow tank 125, and was temporarily stored for further treatment. The filtrate B was analyzed that it still contained 80 mg/L of ammonia nitrogen. And the filter residue D was scraped off from the rotary centrifuge 4 by the scraper and was stored in the temporary storage tank 16. When the reading of the detection device 49 (specifically a flow meter) returns to zero, it means that the solid-liquid mixture in the reaction tank 1-2 has been completely extracted, the valve 73 was thus closed, the pump 188 and the rotary centrifuge 4 were stopped. The main component of the filter residue D 100 was a solid mixture of copper hydroxide and copper carbonate. Water 104 was added to the temporary storage tank 16 for washing of the solid copper compound to remove soluble salts therein.

A method for recycling of PCB copper chloride etching waste solution through precipitation treatment, including following steps:
(1) The acidic etching waste solution to be treated containing 1.8M hydrochloric acid was mixed and reacted with the PCB alkaline etching waste solution with pH 8.3 as an alkaline pH value adjusting agent, until the pH value of the reaction solution reached pH 5.2 and there was copper sludge precipitated;
(2) The solid-liquid mixture obtained after the reaction in step (1) was subjected to SLS to obtain a filtrate A and a filter residue C; and the filtrate A was distributed in three constant volumes according to the process requirements, which were used in preparation of an acidic regenerated etching replenishment solution, an acidic etching oxidant solution and an alkaline regenerated etching replenishment solution; the acidic regenerated etching replenishment solution and the acidic etching oxidant solution were returned to the acidic etching production line for etching recycling, and the alkaline regenerated etching replenishment solution was returned to the alkaline etching production line for etching recycling.
(3) The filter residue C was put into water and mixed with an inorganic base to form a suspension solution, and then ammonia nitrogen removal oxidation reaction was carried out with chlorine gas; the pH value of the reaction solution during the process was controlled at pH 11, the ORP value was controlled to be above 1 mV, and the temperature of the reaction solution was controlled at 5° C.; after reacting for 52 hours, the resulting mixture was subjected to SLS to obtain a filtrate B and a filter residue D, which was a solid mixture mainly contained copper hydroxide and copper carbonate.
(4) The solid copper compound was washed with water to remove soluble salts.

The characteristic of this example is that acid copper chloride etching waste solution and alkaline copper chloride etching waste solution are mixed together for neutralization and precipitation reaction. The obtained filtrate A is divided into three parts according to the process and reused in etching. The filter residue C was treated by the ammonia removal oxidation reaction that adopts the approach (i) in step (3), and the obtained filtrate residue D is washed with water to obtain a solid copper compound. So that the acid copper chloride etching waste solution and the alkaline copper chloride etching waste solution can be treated in an environmentally friendly manner in the production plant and achieve 100% recycling of the waste solution.

### Example 7

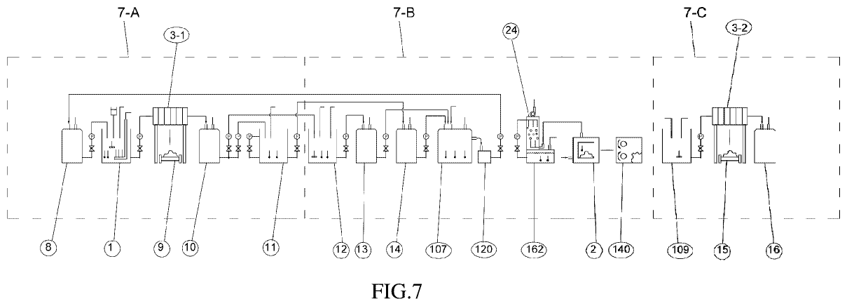

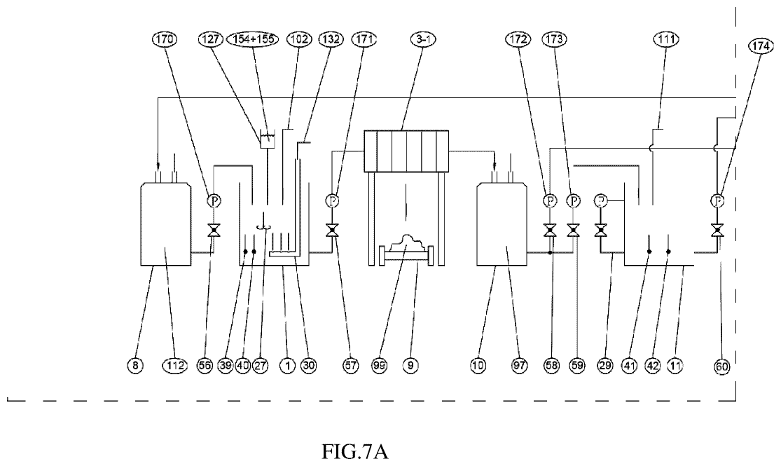

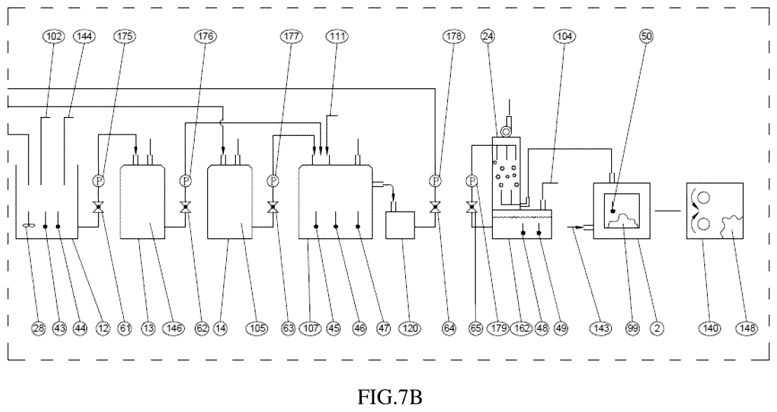

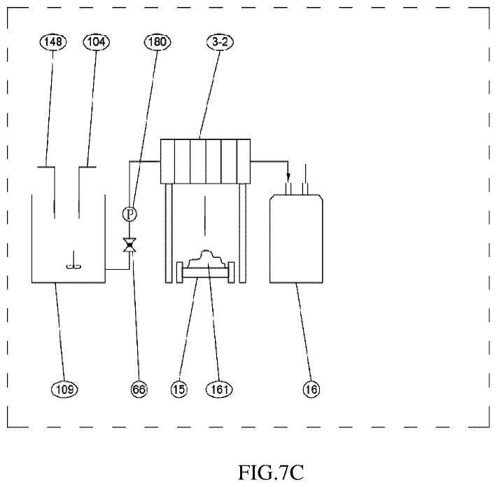

As shown in FIG. 7 and its partial enlarged view FIG. 7A, FIG. 7B and FIG. 7C, an apparatus for recycling of PCB copper chloride etching waste solution through precipitation treatment is provided in this example, including a reaction tank 1, two solid-liquid separators 3-1 and 3-2, ten temporary storage tanks 8-17, twelve detection device, a solid heating device 2, a pulverizer 140, washing tank with a stirring device for copper sludge 110, an tail gas treating device 162 (specifically a spraying tower gas-liquid mixing device), pumps and valves.

An paddle stirring device 27, detection devices 39 and 40 (specifically a pH meter and a liquid-level meter) are provided in the reaction tank 1, which is connected to the solid-liquid separator 3-1 by a pipeline provided with a valve 57 and a pump 171;

The solid-liquid separators 3-1 and 3-2 are both common filter presses.

The temporary storage tank 8 is used to store an acidic etching waste solution, the temporary storage tank 9 is used to store the filter residue C 99, the temporary storage tank 10 is used to store the filtrate A 97 from the solid-liquid separator 3-1, the temporary storage tank 11 is used to prepare an acidic regenerated etching replenishment solution, the temporary storage tank 12 is used to prepare an acidic etching oxidant solution, the temporary storage tank 13 is used to store the acidic etching oxidant solution 146, the temporary storage tank 14 is used to store the acidic regenerated etching replenishment solution 105, and the temporary storage tank 15 is used to store the washed copper oxide powder from the solid-liquid separator 4 (specifically a filter press). The temporary storage tank 16 is used to store the waste solution of water-washing of copper oxide from the solid-liquid separator 4 (specifically a filter press).

The solid heating device 2 is used for heating oxidation treatment for ammonia nitrogen removal on the filter residue C 99, which is a precipitated copper sludge.

The pulverizer 140 is used to mechanically crush and pulverize the copper slag 148 processed by the solid heating device 2.

The washing tank with a stirring device for copper sludge 110 is used for washing copper slag 148 to remove soluble impurities.

The detection device 39 is a pH meter, the detection device 40 is a liquid-level meter, the detection device 41 is a liquid-level meter, the detection device 42 is an acidity meter, the detection device 43 is a pH meter, the detection device 44 is a gravimeter, the detection device 45 is an acidity meter, the detection device 46 is a gravimeter, the detection device 47 is an ORP meter, the detection device 48 is a liquid-level meter, the detection device 49 is a gravimeter, and the detection device 50 is a thermometer.

The acid copper chloride etching waste solution to be treated with an acidity of 1.2M had a copper ion concentration of 140 g/L, and an ammonium chloride concentration of 7 g/L. The alkaline pH value adjusting agents were ammonium carbonate, ammonium bicarbonate, ammonia solution, liquid ammonia.

The process of this example was to turn on the pump 170 to pump the acid copper chloride etching waste solution 112 in the temporary storage tank 8 by a certain volume into the reaction tank 1, and start the paddle stirring device 27. According to the detection device 39 (specifically a pH meter), the addition of the external alkaline pH value adjusting agent was controlled, and in the process, when the pH meter reached the set value pH4.5, all external alkaline pH value adjusting agents were shut down. Precipitates of basic copper chloride and copper ammonia complex formed in the reaction solution. The valve 57 was opened and the pump 171 was turned on to pump the solid-liquid mixture in the reaction tank 1 to the solid-liquid separator 3 (specifically a filter press) for SLS, the obtained filtrate A was led to the temporary storage tank 10, and the filter residue C was left in the solid-liquid separator 3. When the solid-liquid mixture in the reaction tank 1 was completely pumped out, the valve 57 was closed and the pump 171 were turned off. The filter residue C 99 was collected from the solid-liquid separator 3 (specifically a filter press) and put into the temporary storage tank 9, and then the plate-and-frames of the filter press were closed to prepare for the next operation. The valves 58 and 59 were opened and the pumps 172 and 173 were turned on to pump part of the filtrate A 97 in the temporary storage tank 10 to the temporary storage tanks 11 and 12 respectively to prepare acidic regenerated etching replenishment solution and acidic etching oxidant solution. The solutions prepared according to the process were pumped respectively into the temporary storage tanks 13 and 14 for temporary storage.

The solid filter residue C 99 was taken out from the temporary storage tank 9 and put into the solid heating device 2. The heating device was an electric heating device. The solid heating device 2 was turned on to directly heat the filter residue C at 400° C. for 3 hours. According to the process requirements, after the heating oxidation treatment for ammonia removal, the electric heating device 134 was turned off, and the copper slag 148 obtained was taken out and transferred to the pulverizer 140 for crushing. After being pulverized, the copper slag 148 was put into the washing tank 109 and washed with water to remove soluble salt impurities in the copper slag 148. And then, the pump 180 was turned on to pump the solid-liquid mixture in the washing tank 109 to the solid-liquid separator 3-2 for SLS, and the cleaning waste solution was led into the temporary storage tank 16 for further processing. The filter residue 161 which was copper oxide was collected from the solid-liquid separator 3-2 and put in the temporary storage tank 15 for temporary storage.

During the heating oxidation treatment for ammonia removal, the acidic tail gas containing ammonium chloride escaped from the solid heating device 2 and was led to the spraying tower gas-liquid mixing device 24 for absorption and treatment, and the waste solution of the tail gas treating device 162 was left for further processing. The tail gas treating device 162 was provided with a detection device 48 (specifically a liquid-level meter) and a detection device 49 (specifically a gravimeter) to control the replacement of the tail gas absorption solution.

A method for recycling of PCB copper chloride etching waste solution through precipitation treatment, including following steps:
(1) A PCB acidic etching waste solution to be treated was mixed with an alkaline pH value adjusting agent to react until the pH value of the reaction solution reached pH4.5 and there was precipitated copper sludge;
(2) The mixture obtained after the reaction in step (1) was subjected to SLS to obtain a filtrate A and a filter residue C;
(3) The filter residue C was subjected to electric heating oxidation treatment for ammonia removal at 400° C., and copper oxide was formed during the reaction.
(4) The filtrate A was taken to respectively prepare an acidic regenerated etching replenishment solution and an acidic etching oxidant solution, which were used in the acidic etching production line.
(5) The copper slag after the heating oxidation treatment was mechanically crushed and washed with water to remove salt, and the copper oxide powder product was obtained after SLS.

The characteristic of this example is that the acid copper chloride etching waste solution is mixed, neutralized and precipitated in the factory area of the PCB production enterprise. The approach (ii) in step (3) is adopted in the process. This example can reduce process and equipment that requires ammonia nitrogen removal oxidant, and its operation is safe and simple and saves a lot of equipment investment funds. After further environmental protection treatment of the wastewater generated in the process containing ammonia nitrogen, the ideal effect of 100% recycling of acid copper chloride etching waste solution can be achieved without using the electrolysis method to obtain copper.

### Example 8

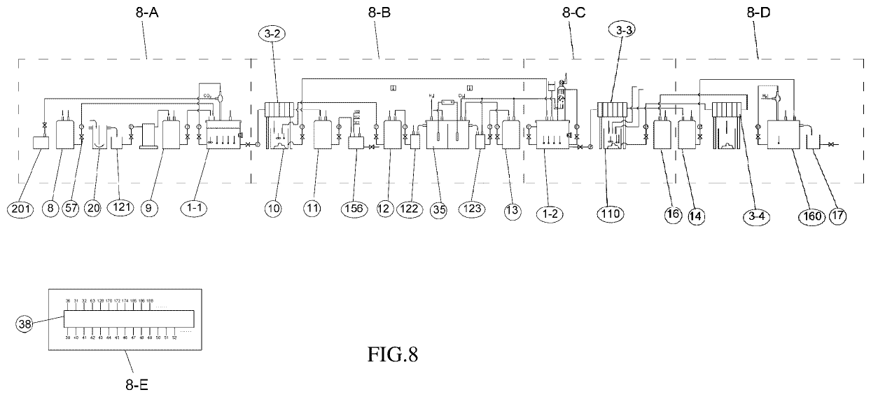

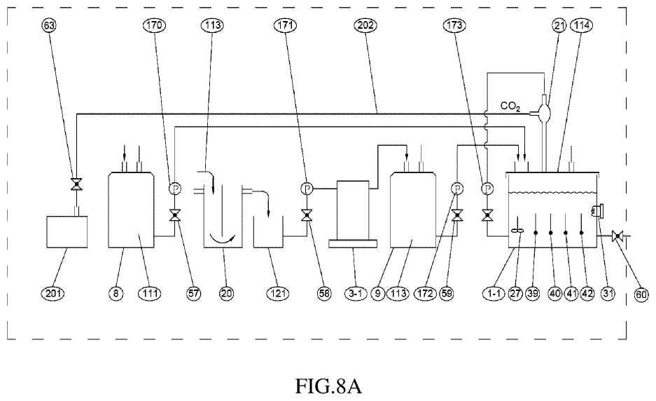

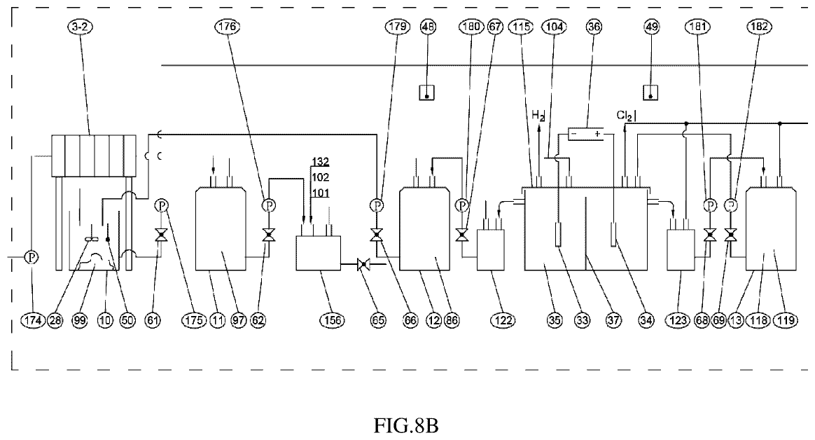

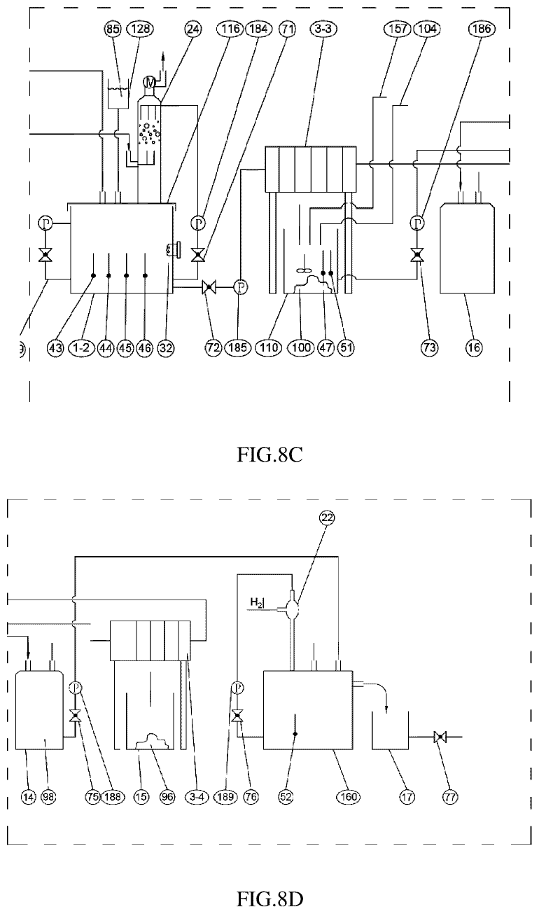

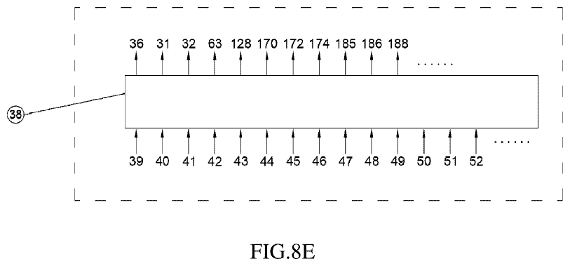

As shown in FIG. 8 and its partial enlarged view FIG. 8A, FIG. 8B, FIG. 8C, FIG. 8D and FIG. 8E, an apparatus for recycling of PCB copper chloride etching waste solution through precipitation treatment is provided in this example, including two reaction tanks, four solid-liquid separators, eight temporary storage tanks, two heat exchange devices, a water oil separator, a solid feeder, a set of chlorine gas generator that applies electrolysis, a washing tank with a stirring device for copper sludge, fourteen detection devices, an automatic detection and feeding controller, a hydrogen eliminator, a chemical reactor 156, a CO₂ source.

A paddle stirring device 27, a sealing tank cover 114, a heat exchange device 31, a detection device 39 (specifically a pH meter), a detection device 40 (specifically a gravimeter), a detection device 41 (specifically a thermometer), the detection device 42 (specifically a liquid-level meter) are provided in the reaction tank 1-1. The reaction tank 1-2 is provided with a sealing tank cover 115, a liquid circulator 29, a heat exchange device 32, a spraying tower gas-liquid mixing device 24, a detection device 43 (specifically a pH meter), a detection device 44 (specifically an ORP meter), a detection device 45 (specifically a thermometer), and a detection device 46 (specifically a liquid-level meter).

The solid-liquid separator 3-1 is an ordinary filter with a filter medium structure, while the solid-liquid separators 3-2 to 3-4 are ordinary plate-and-frame filter presses.

The temporary storage tanks shown in FIG. 2 are used for temporary storage of different solutions. Wherein a paddle stirring device 28 and a detection device 50 (specifically a liquid-level meter) are provided in the temporary storage tank 10.

A water-oil separator 20 and a solid-liquid separator 3-1 are used to remove impurities from the alkaline cupric chloride ammonia etching waste solution that needs to be treated. After impurity removal, the solution is led to the temporary storage tank 9 for storage.

The components of the acidic pH value adjusting agents were carbon dioxide gas 202 and hydrochloric acid 111 respectively. The pH value of the alkaline copper chloride ammonia etching waste solution 113 to be treated was pH 8.3, and its main component was a mixture of ammonia solution, ammonium chloride and cupric chloride ammonia.

The solid feeder 128 was loaded with sodium hydroxide 85, which was waited to be added into the reaction tank 1-2 to adjust the pH value of the reaction solution of the oxidation treatment for ammonia nitrogen removal.

The electrolytic cell separator 37 in the chlorine gas generator that applies electrolysis is a cation exchange membrane, and chlorine gas 95, hydrogen gas, and sodium hydroxide solution 86 were obtained by electrolyzing the sodium chloride solution. Electrolyzed hydrogen was introduced into the hydrogen eliminator 160 through the vacuum jetting gas-liquid mixing device 22 to react with the oxidant for safety treatment. Chlorine gas 95 was led into the reaction tank 1-2 to participate in the chemical reaction through the spraying tower gas-liquid mixing device 24.

The automatic detection and feeding controller 38 obtains field data through multiple detection devices for automatic control of the production process of the whole apparatus.

The washing tank with a stirring device for copper sludge 110 is specially used for washing the filter residue D with water, and a detection device 47 (specifically a pH meter) and a detection device 51 (specifically a photoelectric colorimeter) are provided in the tank to detect the pH value and the copper salt concentration in the washing liquid, and perform impurity removal treatment on the copper hydroxide therein.

The process of this example adopted the approach (i) in step (3), the alkaline copper chloride ammonia etching waste solution 113 to be treated was pumped into the water-oil separator 20, and passed through the filter 4 for impurity removal treatment and then into the temporary storage tank 9. The pump 172 was turned on to pump the alkaline etching waste solution into the reaction tank 1-1 at a constant volume. The paddle stirring device 27 and the heat exchange device 31 were turned on. The temperature, copper ion concentration, pH value, and liquid level of the reaction solution were all detected by a detection device 41 (specifically a thermometer), a detection device 40 (specifically a gravimeter), a detection device 39 (specifically a pH meter), a the detection device 40 (specifically a liquid-level meter). The on-site detection data were sent to the automatic detection and feeding controller 38 for processing and program execution. According to the process, the solution in the reaction tank 1-1 was processed by opening valve 63 and sending carbon dioxide gas 202 into the solution in tank 1 through the vacuum jetting gas-liquid mixing device 21 for gas-liquid mixed reaction, the precipitate was observed when the pH value of the reaction solution was reduced to pH 7.2, and then the control pump 170 was turned on to introduce an acidic pH value adjusting agent into the solution in the reaction tank 1-1 to adjust the pH value to pH 7.0 so that a large amount of precipitates were deposited from the reaction solution. When the detected value of the detection device 40 (specifically a gravimeter) decreased to the set value, the precipitation reaction was considered to be completed. The valve 60 was opened and the pump 174 was turned on to pump the solid-liquid mixture in the reaction tank 1-1 to the solid-liquid separator 5 (specifically a filter press) for SLS. When the solution in the reaction tank 1-1 is evacuated, close the valve 60 and turn off the pump 174. The filtrate A 97 is diverted to the temporary storage tank 11 for storage, and the filter residue C is retained in the solid-liquid separator 5 (specifically a filter press). When the solution in the reaction tank was completely pumped out, the valve 60 was closed and the pump 174 was turned off. The filtrate A 97 was led to the temporary storage tank 11 for storage, and the filter residue C was left in the solid-liquid separator 5. After completing the treatment of the reaction tank 1, the plate-and-frames of the solid-liquid separator 5 (specifically a filter press) were opened to collect the filter residue C and put it in the temporary storage tank 10. The main component of the filter residue C was copper chloride ammonium complex salt. The plate-and-frames of the solid-liquid separator 5 were closed again to prepare for the next operation. The sodium hydroxide solution 86 solution in the temporary storage tank 12 was added into the temporary storage tank 10 according to the control of the detection device 50 (specifically a liquid-level meter), and the paddle stirring device 28 was turned on to make the precipitate into a suspension solution. The ammonia nitrogen content of the suspension solution in the tank 10 was analyzed by technicians, and the resulted NH⁴⁺ ion concentration was 21 g/L. By opening the valve 61 and turning on the pump 175, all the suspension in the temporary storage tank 10 was added to the reaction tank 1-2. When the solution in the temporary storage tank 10 was completely pumped out, the valve 61 was closed and the pump 175 was turned off, the pump 184 and the liquid circulator 29 were turned on. The jet pump 189 of the hydrogen eliminator 160 was turned on to let the vacuum jetting gas-liquid mixing device 22 generate a vacuum negative pressure to prepare for inhaling the electrolyzed hydrogen. The chlorine gas generator that applies electrolysis, the solid feeder 128 and the heat exchange device 32 were turned on to allow normal operation of the ammonia nitrogen removal reaction. In the process, the on-site detection data of the detection device 43 (specifically a pH meter), the detection device 44 (specifically an ORP meter), the detection device 45 (specifically a thermometer), the detection device 46 (specifically a liquid-level meter) and the detection device 47 (specifically an ORP meter) in the hydrogen eliminator 160 were sent to the automatic detection and feeding controller 38 for processing. The output current magnitude of the electrolytic power supply was adjusted by the automatic detection and feeding controller 38 according to the on-site ORP value and the on-site pH value of the solution during the oxidation reaction for ammonia nitrogen removal, in order to control the amount of electrolytic chlorine gas and the motion of the solid feeder 128. Simultaneously, the pump 188 was used for adding an oxidizing agent to the hydrogen eliminator 160 according to the data detected by the detection device 47. During the reaction in the reaction tank 1-2 according to the process, the ORP value was controlled to be above 950 mV, the pH value was controlled to be pH7.5, the temperature of the reaction solution was controlled at room temperature and was maintained for 36 hours, and the concentration of NH⁴⁺ ions after reaction was resulted to be 50 mg/L which was considered to be the completion of the reaction. The chlorine gas generator that applies electrolysis, the pumps 183 and 184, the liquid circulator 29 and the heat exchange device 32 were turned off, the valve 72 was opened and the pump 185 was turned on to pump the solid-liquid mixture in the reaction tank 1-2 into the solid-liquid separator 6 (specifically a filter press) for SLS, the filtrate B was directed into the temporary storage tank 14, and the filter residue D whose main component was copper hydroxide was left in the solid-liquid separator 6 (specifically a filter press). The valve 72 was closed and the pump 185 was turned off after the mixed liquid in the reaction tank 1-2 was pumped out. The plate-and-frames of the solid-liquid separator 6 (specifically a filter press) were opened, the filter residue D 100 was taken out and transferred into the washing tank with a stirring device for copper sludge 110, water 104 was added to the washing tank 110, the paddle stirring device in the tank was turned on for washing, the pH value of the washing liquid and the copper salt concentration in the solution were monitored according to the detected result of the detection device 47 (specifically a pH meter) and the detection device 51 (specifically a photoelectric colorimeter), and the valve 73 was opened and the pump 186 was turned on to pump the solid-liquid mixture in the washing tank 110 into the solid-liquid separator 7 (specifically a filter press) for SLS after meeting the washing requirements. Its filtrate was diverted back to the temporary storage tank 16 and waited to be treated, and the filter residue copper hydroxide 96 was left in the solid-liquid separator 7 (specifically a filter press). After the solid-liquid mixture in the tank 110 was pumped out, the valve 73 was closed and the pump 186 was turned off. The plate-and-frames of the solid-liquid separator 7 (specifically a filter press) were opened and the filter residue copper hydroxide 96 was taken out and stored in the temporary storage tank 15 for further recovery, and then the plate-and-frames were reclosed and prepared for the next operation.

Filtrate A was concentrated according to process requirements. The solution in the tank 11 was pumped to the chemical reactor 156 to prepare the alkaline regenerated etching replenishment solution, and solid ammonium chloride was added to the concentrated solution of the filtrate A in the chemical reactor 156 to supplement the chloride ion concentration, and the ammonia content of the alkaline regenerated etching replenishment solution 106 was adjusted by adding liquid ammonia 132 and/or ammonia solution 102, and the obtained alkaline regenerated etching replenishment solution was reused in the alkaline etching production line 108.

The analytical result of the ammonia nitrogen impurity content of filtrate B was 50 mg/L. And the filtrate B was diverted to the temporary storage tank 14 to be used as an oxidant in the subsequent treatment.

During the operation, the detection data of the workshop site was transmitted through the detection device 48 (specifically a hydrogen gas detector) and the detection device 49 (specifically a chlorine gas detector) to the automatic detection and feeding controller 38 for processing and interlocking with the production system for safety.

A method for recycling of PCB copper chloride etching waste solution through precipitation treatment, including following steps:
(1) A PCB alkaline copper chloride ammonia etching waste solution with pH8.3, which was pre-treated for impurity removal, was mixed with carbon dioxide gas as an acidic pH value adjusting agent for gas-liquid mixing reaction and acidification, so that the pH value of the reaction solution was reduced to pH7.2, and then hydrochloric acid was added until the pH value of the reaction solution reached pH7.0 and there was copper sludge precipitated.
(2) The solid-liquid mixture obtained after the reaction in step (1) was subjected to SLS to obtain a filtrate A and a filter residue C.
(3) The filter residue C was mixed with the inorganic base solution and carried out the ammonia removal oxidation reaction with chlorine gas. During this period, the pH value of the reaction solution was maintained at pH 7.5 by adding sodium hydroxide through the solid feeder, and the oxidant chlorine gas was added until the ORP value of the reaction solution reached and maintained in the numerical range above 950 mV. The temperature of the reaction solution was at room temperature and the reaction was carried out for 36 hours; the solid-liquid mixture was subjected to SLS, obtaining a filtrate B and a filter residue D whose main component was copper hydroxide.
(4) The filter residue D obtained in step (3) was washed with water to obtain purified recycled copper hydroxide.
(5) The concentrated solution of the filtrate A was used in preparation of an alkaline regenerated etching replenishment solution for reuse on the alkaline etching production line.

This example of the present disclosure is to illustrate the neutralization and copper sludge precipitation recovery of an alkaline cupric chloride ammonia etching waste solution using a combination of carbon dioxide gas and hydrochloric acid as an acidic pH value adjusting agent. Wherein, carbon dioxide firstly reacts with the free ammonia in the waste solution to generate ammonium bicarbonate and reduce the pH value of the solution, so that the volume of the neutralization reaction solution does not increase significantly, and the volume of the filtrate A 97 will not increase, avoiding excess waste solution which cannot be reused. Chlorine oxidant is used under alkaline conditions in the oxidation reaction for ammonia removal on the suspension solution of the precipitated copper sludge. During the process of oxidation reaction for ammonia removal, as the pH value and basicity of the reaction solution are controlled to be low, sodium percuprate is difficult to be generated even under high ORP value. Therefore, copper hydroxide is obtained in the reaction of oxidizing copper chloride ammonium complex. In the process of electrolytic chlorine production, the hydrogen gas generated on the electrolytic cathode is also introduced into the hydrogen eliminator, and the oxidant filtrate B 98 is utilized to react with hydrogen gas for safety treatment. In this example, the filtrate A produced in the process of neutralization and copper sludge precipitation was utilized to prepare a regenerated etching replenishment solution according to the process requirements and reused in the alkaline etching production line.

What is claimed is:

1. A method for recycling of PCB copper chloride etching waste solution through precipitation treatment, comprising the following steps:
(1) mixing a PCB copper chloride etching waste solution with a pH value adjusting agent for reaction, so that copper salt precipitates in the solution and a solid-liquid mixture is obtained, and at least one of the PCB copper chloride etching waste solution and the pH value adjusting agent contains a PCB copper chloride etching waste solution containing ammonium and/or ammonia; and
(2) subjecting a solid-liquid mixture obtained in step (1) to SLS to obtain filtrate A and filter residue C; and
(3) carrying out ammonia nitrogen removal treatment on the filter residue C to generate recovered copper products; and
(4) reusing all or part of the filtrate A directly or after composition adjustment to the PCB copper chloride etching system as a regenerated etching replenishment solution and/or an etching oxidant solution.

2. The method for recycling of PCB copper chloride etching waste solution through precipitation treatment according to claim 1, wherein the main component of the recovered copper product mentioned in step (3) is at least one selected from the group consisting of copper hydroxide, copper carbonate, basic copper carbonate, copper oxide and percuprate salt.

3. The method for recycling of PCB copper chloride etching waste solution through precipitation treatment according to claim 1, wherein the pH value adjusting agent in step (1) includes acidic pH value adjusting agent and alkaline pH value adjusting agent; the acidic pH value adjusting agent is at least one selected from the group consisting of PCB acid copper chloride etching waste solution, hydrochloric acid, organic acid, and carbon dioxide. The alkaline pH value adjusting agent is at least one selected from the group consisting of PCB alkaline cupric chloride ammonia etching waste solution, sodium hydroxide, potassium hydroxide, ammonia and/or ammonium hydroxide, sodium carbonate, sodium bicarbonate, potassium bicarbonate, ammonium carbonate, and ammonium bicarbonate; the organic acid in the acidic pH value adjusting agent is formic acid.

4. The method for recycling of PCB copper chloride etching waste solution through precipitation treatment according to claim 3, wherein when the acidic pH value adjusting agent includes carbon dioxide, carbon dioxide is firstly used to adjust the pH of the alkaline PCB copper chloride etching waste solution downward until a copper salt is precipitated and the resulting pH is greater than 7, and then at least one acidic pH value adjusting agent selected from the group consisting of PCB acid copper chloride etching waste solution, hydrochloric acid, and organic acid is used to further adjust the pH downward; when using at least one acidic pH value adjusting agent selected from the group consisting of PCB acid copper chloride etching waste solution, hydrochloric acid, and organic acid to further adjust the pH value downward, the resulting pH value is not lower than 7, so as to generate as much copper salt precipitate as possible and avoid a large amount of carbon dioxide release.

5. The method for recycling of PCB copper chloride etching waste solution through precipitation treatment according to claim 1, wherein the ammonia nitrogen removal treatment in step (3) applies at least one of the following approaches: (i) mixing the filter residue C with an ammonia nitrogen removal oxidant to perform oxidation reaction for ammonia nitrogen removal; (ii) direct heating for oxidation treatment on the filter residue C to remove ammonia.

6. The method for recycling of PCB copper chloride etching waste solution through precipitation treatment according to claim 5, wherein the ammonia nitrogen removal oxidant is a hypochlorite salt and/or chlorine gas, and the ammonium salt and/or ammonia in the filter residue C are removed by utilizing the oxidizing ability of a hypochlorite salt and/or chlorine gas, and nitrogen gas is generated during the reaction; the hypochlorite salt is specifically potassium hypochlorite and/or sodium hypochlorite; when the ammonia nitrogen removal oxidation reaction is adopted in step (3), supplementary inorganic base is added to the reaction mixture during the ammonia nitrogen removal treatment to maintain the pH value of the reaction solution at ≥6.8.

7. The method for recycling of PCB copper chloride etching waste solution through precipitation treatment according to claim 6, wherein when the filter residue C contains iron hydroxide, the ammonia nitrogen removal oxidation reaction is carried out at a higher reaction solution basicity, a higher reaction solution ORP value and a higher reaction temperature.

8. The method for recycling of PCB copper chloride etching waste solution through precipitation treatment according to claim 1, wherein in step (4), there are several approaches as follows:
when reusing to the alkaline etching process only, take the filtrate A to prepare an alkaline regenerated etching replenishment solution according to the process requirements with at least one selected from the group consisting of ammonia solution, liquid ammonia, ammonium chloride, and other additives, and reuse it on the alkaline etching production line;
when reusing to the acidic etching process only, take the filtrate A to prepare an acid regenerated etching replenishment solution and/or an acid etching oxidant and reuse them on the acid etching production line; at this time, according to the process conditions, the filtrate A is distributed for the reuse amount of the acid regenerated etching replenishment solution and the acid etching oxidant solution. During the preparation process, the filtrate A has its composition adjusted according to the process requirements and is reused in the acidic etching system as a regenerated etching replenishment solution; if the filtrate A is acidic, it can be used directly or after composition adjustment as an acidic regenerated etching replenishment solution for reuse in the acidic etching system; when the filtrate A is used to prepare an acidic etching oxidant and reused in the acidic etching system, the filtrate A is adjusted to neutral or basic condition and mixed with sodium chlorate and/or potassium chlorate to prepare a chemically stable solution mixture as an acidic etching oxidant;
when reusing to both the acidic etching process and the alkaline etching process, according to the process requirements, the filtrate A is distributed according to the preparation requirements of the alkaline regenerated etching replenishment solution, acidic regenerated etching replenishment solution and/or acidic etching oxidant, and then used in the etching process directly or after composition adjustment as in the above-mentioned approaches (1) and (2) according to the process requirements.

9. The method for recycling of PCB copper chloride etching waste solution through precipitation treatment according to claim 1, wherein when the PCB copper chloride etching waste solution in step (1) contains alkaline etching waste solution, the alkaline etching waste solution is firstly heated to remove ammonia; or, when the PCB copper chloride etching waste solution in step (1) contains PCB alkaline copper chloride ammonia etching waste solution, the PCB alkaline copper chloride ammonia etching waste solution is firstly heated to ≥55° C. for removing ammonia; or, before step (1), the acidic etching waste solution and/or the alkaline etching waste solution are subjected to water-oil separation and/or SLS treatment respectively, so that the photoresist residue and the solid impurities in the acidic etching waste solution are removed, and/or the photoresist residue, stannous hydroxide precipitate and other solid impurities in the alkaline etching waste solution are removed.

10. An apparatus for recycling of PCB copper chloride etching waste solution through precipitation treatment according to claim 1, comprising at least one reaction tank (1) or its combination with at least one solid heating device (2), at least one solid-liquid separator (3), and at least one temporary storage tank (8-18), wherein, at least two selected from the group consisting of the reaction tank (1), the solid-liquid separator (3) and the temporary storage tank (8-18) are connected through a pipeline or through a pipeline provided with a pump and/or a valve;
the reaction tank (1) is used for mixing the PCB copper chloride etching waste solution and the pH value adjusting agent to react and form a copper sludge precipitate, and/or for mixing the precipitated copper sludge and the ammonia nitrogen removal oxidant to carry out the ammonia nitrogen removal oxidation reaction in step (3).

11. An apparatus for recycling of PCB copper chloride etching waste solution through precipitation treatment according to claim 2, comprising at least one reaction tank (1) or its combination with at least one solid heating device (2), at least one solid-liquid separator (3), and at least one temporary storage tank (8-18), wherein, at least two selected from the group consisting of the reaction tank (1), the solid-liquid separator (3) and the temporary storage tank (8-18) are connected through a pipeline or through a pipeline provided with a pump and/or a valve;
the reaction tank (1) is used for mixing the PCB copper chloride etching waste solution and the pH value adjusting agent to react and form a copper sludge precipitate, and/or for mixing the precipitated copper sludge and the ammonia nitrogen removal oxidant to carry out the ammonia nitrogen removal oxidation reaction in step (3).

12. An apparatus for recycling of PCB copper chloride etching waste solution through precipitation treatment according to claim 3, comprising at least one reaction tank (1) or its combination with at least one solid heating device (2), at least one solid-liquid separator (3), and at least one temporary storage tank (8-18), wherein, at least two selected from the group consisting of the reaction tank (1), the solid-liquid separator (3) and the temporary storage tank (8-18) are connected through a pipeline or through a pipeline provided with a pump and/or a valve;
the reaction tank (1) is used for mixing the PCB copper chloride etching waste solution and the pH value adjusting agent to react and form a copper sludge precipitate, and/or for mixing the precipitated copper sludge and the ammonia nitrogen removal oxidant to carry out the ammonia nitrogen removal oxidation reaction in step (3).

13. An apparatus for recycling of PCB copper chloride etching waste solution through precipitation treatment according to claim 4, comprising at least one reaction tank (1) or its combination with at least one solid heating device (2), at least one solid-liquid separator (3), and at least one temporary storage tank (8-18), wherein, at least two selected from the group consisting of the reaction tank (1), the solid-liquid separator (3) and the temporary storage tank (8-18) are connected through a pipeline or through a pipeline provided with a pump and/or a valve;
the reaction tank (1) is used for mixing the PCB copper chloride etching waste solution and the pH value adjusting agent to react and form a copper sludge precipitate, and/or for mixing the precipitated copper sludge and the ammonia nitrogen removal oxidant to carry out the ammonia nitrogen removal oxidation reaction in step (3).

14. An apparatus for recycling of PCB copper chloride etching waste solution through precipitation treatment according to claim 5, comprising at least one reaction tank (1) or its combination with at least one solid heating device (2), at least one solid-liquid separator (3), and at least one temporary storage tank (8-18), wherein, at least two selected from the group consisting of the reaction tank (1), the solid-liquid separator (3) and the temporary storage tank (8-18) are connected through a pipeline or through a pipeline provided with a pump and/or a valve;
the reaction tank (1) is used for mixing the PCB copper chloride etching waste solution and the pH value adjusting agent to react and form a copper sludge precipitate, and/or for mixing the precipitated copper sludge and the ammonia nitrogen removal oxidant to carry out the ammonia nitrogen removal oxidation reaction in step (3).

15. An apparatus for recycling of PCB copper chloride etching waste solution through precipitation treatment according to claim 6, comprising at least one reaction tank (1) or its combination with at least one solid heating device (2), at least one solid-liquid separator (3), and at least one temporary storage tank (8-18), wherein, at least two selected from the group consisting of the reaction tank (1), the solid-liquid separator (3) and the temporary storage tank (8-18) are connected through a pipeline or through a pipeline provided with a pump and/or a valve;
the reaction tank (1) is used for mixing the PCB copper chloride etching waste solution and the pH value adjusting agent to react and form a copper sludge precipitate, and/or for mixing the precipitated copper sludge and the ammonia nitrogen removal oxidant to carry out the ammonia nitrogen removal oxidation reaction in step (3).

16. An apparatus for recycling of PCB copper chloride etching waste solution through precipitation treatment according to claim 7, comprising at least one reaction tank (1) or its combination with at least one solid heating device (2), at least one solid-liquid separator (3), and at least one temporary storage tank (8-18), wherein, at least two selected from the group consisting of the reaction tank (1), the solid-liquid separator (3) and the temporary storage tank (8-18) are connected through a pipeline or through a pipeline provided with a pump and/or a valve;
the reaction tank (1) is used for mixing the PCB copper chloride etching waste solution and the pH value adjusting agent to react and form a copper sludge precipitate, and/or for mixing the precipitated copper sludge and the ammonia nitrogen removal oxidant to carry out the ammonia nitrogen removal oxidation reaction in step (3).

17. An apparatus for recycling of PCB copper chloride etching waste solution through precipitation treatment according to claim 8, comprising at least one reaction tank (1) or its combination with at least one solid heating device (2), at least one solid-liquid separator (3), and at least one temporary storage tank (8-18), wherein, at least two selected from the group consisting of the reaction tank (1), the solid-liquid separator (3) and the temporary storage tank (8-18) are connected through a pipeline or through a pipeline provided with a pump and/or a valve;
the reaction tank (1) is used for mixing the PCB copper chloride etching waste solution and the pH value adjusting agent to react and form a copper sludge precipitate, and/or for mixing the precipitated copper sludge and the ammonia nitrogen removal oxidant to carry out the ammonia nitrogen removal oxidation reaction in step (3).

18. An apparatus for recycling of PCB copper chloride etching waste solution through precipitation treatment according to claim 9, comprising at least one reaction tank (1) or its combination with at least one solid heating device (2), at least one solid-liquid separator (3), and at least one temporary storage tank (8-18), wherein, at least two selected from the group consisting of the reaction tank (1), the solid-liquid separator (3) and the temporary storage tank (8-18) are connected through a pipeline or through a pipeline provided with a pump and/or a valve;
the reaction tank (1) is used for mixing the PCB copper chloride etching waste solution and the pH value adjusting agent to react and form a copper sludge precipitate, and/or for mixing the precipitated copper sludge and the ammonia nitrogen removal oxidant to carry out the ammonia nitrogen removal oxidation reaction in step (3).
